(19) United States
(12) Patent Application Publication
(10) Pub. No.: US 2018/0330284 A1
(43) Pub. Date: Nov. 15, 2018

(54) RESERVATION-MANAGEMENT SYSTEM AND RESERVATION-MANAGEMENT SERVER

(71) Applicant: KYOCERA Document Solutions Inc., Osaka (JP)

(72) Inventor: Sumitaka OKUDA, Osaka (JP)

(73) Assignee: KYOCERA Document Solutions Inc., Osaka (JP)

(21) Appl. No.: 15/975,979

(22) Filed: May 10, 2018

(30) Foreign Application Priority Data
May 10, 2017 (JP) 2017-094107

(51) Int. Cl. G06Q 10/02

(52) U.S. Cl. CPC G06Q 10/02; G06F 3/1272

(57) ABSTRACT

A decrease in user convenience and availability of an image forming apparatus is suppressed. A reservation-management system includes a reservation server and a shared apparatus that is installed in a store. A first system-control unit of the reservation-management server receives a reservation request that includes a reservation time from a portable terminal, and searches for the store based on the reservation request. Then, the first system-control unit notifies the portable terminal of the store-position information of the searched stored and a reservation number, and transmits the reservation time and reservation number to the shared apparatus based on a management code. Together with this, the first system-control unit gives an instruction for a standby time for restricting the use of the functions of the shared apparatus by other users before the start of the reservation time. A second system-control unit of the shared apparatus releases the restriction on the use of the function when there is no input of the reservation number even though a fixed amount of time has elapsed from the reservation time.

### INCORPORATION BY REFERENCE

This application is based on and claims the benefit of priority from Japanese Patent Application No. 2017-094107 filed on May 10, 2017 the contents of which are hereby incorporated by reference.

### BACKGROUND

The present disclosure relates to a reservation-management system and a reservation-management server that are suited, for example, to reservations of an image forming apparatus.

In recent years, as one form of using an image forming apparatus that is an MFP such as a multifunction printer, multifunction peripheral, and the like that is installed in a convenience store, for example, there is a service called net printing, for example. In this service, a user ID and password that are obtained by a user registering beforehand are used, a file to be printed is registered via a network, for example, and a reservation number is obtained. After that, the user goes to the convenience store, enters the reservation number, and performs printing of the previously registered file.

In this case when registering the file, by making it possible to reserve the time for using the image forming apparatus, wait time can be eliminated even when there are many users of the image forming apparatus, so this is considered to further improve the service to the user.

As such a method related to reserving an image forming apparatus, in a typical example, a printing service providing method is proposed for providing an optimal copy server for a user that is registered on a server via a network. In this printing service providing method, a user-reservation terminal has a service-reservation-condition-information-generating unit for generating service-reservation-condition information, and a service-reservation-condition-information-transmitting unit for transmitting service reservation-condition information to a server terminal. Moreover, in this printing-service-providing method, a dealer-reservation-receiving terminal has a service-receivable-condition-information-generating unit for generating service-receivable-condition information, and a service-receivable-condition-information-transmitting unit for transmitting service-receivable-condition information to a server terminal that is located the closest. Furthermore, in this printing-service-providing method, the server terminal includes: a condition-comparing unit that compares the service-reservation-condition information that is transmitted by the user-reservation terminal and the service-receivable-condition information that is transmitted by the dealer-reservation terminal; a reservation-condition-suitability-calculating unit for calculating the suitability of the service-reservation conditions from the comparison results by the condition-comparing unit; and a service-receiving-information-transmitting unit for transmitting service-receiving information based on the high-user-suitability-service-receivable-condition information having a suitability that is equal to or greater than a predetermined user-standard-condition-suitability to the user-reservation terminal. In addition, this printing-service-providing method performs a printing service reservation by the user-reservation terminal transmitting service reservation data to the dealer-reservation-receiving terminal, which is the transmitting source of service-receiving-information data.

### SUMMARY

The reservation-management system according to the present disclosure includes a reservation-management server, a shared apparatus that is installed in a store, and a portable terminal that requests a reservation for the shared apparatus via the reservation-management server. The reservation-management server has: a first reservation-management unit for managing a store code for identifying the store, store-position information that indicates the position of the store, a management code for managing the shared apparatus, and reservation information that includes a reservation time and reservation number; and a first system-control unit. The first system-control unit receives a reservation request from the portable terminal that includes the reservation time, searches for the store based on the reservation request, causes the first reservation-management unit to manage the reservation time by correlating the reservation time with the store code of the searched store, notifies the portable terminal of the store-position information of the searched store and the reservation number, and transmits the reservation time and the reservation number to the shared apparatus based on the management code. Together with this, the first system-control unit gives an instruction for a standby time for restricting the use of the functions of the shared apparatus by other users before the start of the reservation time. The shared apparatus has: a second reservation-management unit for managing the reservation time, the reservation number and the standby time; and a second system-control that sets a standby time for restricting use by other users before the start of the reservation time managed by the second reservation-management unit, and restricts use of the functions. The, the second system-control unit releases the restrictions on use of the functions when there is no input of the reservation number even after a fixed amount of time has elapsed from the reservation time.

The reservation-management server according to the present disclosure includes: a first reservation-management unit that manages a store code for identifying a store where an image forming apparatus is installed, store-position information of the store, a management code for managing the image forming apparatus, and reservation information that includes a reservation time and reservation number; and a first system-control unit. The first system-control unit receives a reservation request from the portable terminal that includes the reservation time, and terminal-position information that indicates the position of the portable terminal, and searches for the store based on the store-position information and the terminal-position information. Then, the first system-control unit causes the first reservation management unit to manage the reservation time by correlating the reservation time with the store code of the searched store, notifies the portable terminal of the store-position information and the reservation number of the searched store, and transmits the reservation time and reservation number to the image forming apparatus based on the management code. Together with this, the first system-control unit gives an instruction for a standby time for restricting the use of the functions of the image forming apparatus by other users before the start of the reservation time.

The reservation-management server according to the present disclosure includes: a first reservation-management unit that manages a store code for identifying a store where an image forming apparatus is installed, a management code for managing the image forming apparatus, and reservation information that includes a reservation time and reservation number; and a first system-control unit that receives a reservation request from the portable terminal that includes the store code and the reservation time, causes the first reservation management unit to manage the reservation time by correlating the reservation time with the store code, transmits the reservation time and reservation number to the image forming apparatus according to the management code, and together with this, gives an instruction for a standby time for restricting the use of the functions of the image forming apparatus by other users before the start of the reservation time.

### BRIEF DESCRIPTION OF THE DRAWINGS

FIG. 1 illustrates an embodiment of a reservation-management system according to the present disclosure.

FIG. 2 illustrates an example of configuration of a reservation-management server, MFP and portable terminal in FIG. 1.

FIG. 3A is a diagram for explaining a reservation management table that is managed by a reservation-management server in FIG. 1, and illustrates a reservation management table that is managed by the reservation-management server on the store chain A side.

FIG. 3B is a diagram for explaining a reservation management table that is managed by a reservation-management server in FIG. 1, and illustrates a reservation management table that is managed by the reservation-management server on the store chain B side.

FIG. 4A is a diagram for explaining contents that are displayed on the panel unit of the portable terminal in FIG. 1 related to reserving an MFP, and illustrates a login screen when making a login request to the reservation-management server in FIG. 1.

FIG. 4B is a diagram for explaining contents that are displayed on the panel unit of the portable terminal in FIG. 1 related to reserving an MFP, and illustrates a reservation screen (A) that is displayed when user authentication on the reservation-management server side in FIG. 1 is successful.

FIG. 4C is a diagram for explaining contents that are displayed on the panel unit of the portable terminal in FIG. 1 related to reserving an MFP, and similar to FIG. 4B, illustrates a reservation screen (A) that is displayed when user authentication on the reservation-management server side in FIG. 1 is successful.

FIG. 5A is a diagram for explaining contents that are displayed on the panel unit of the portable terminal in FIG. 1 related to reserving an MFP, and illustrates a reservation-complete screen (B) that is displayed when the reservation-management server on the store chain A side receives a reservation.

FIG. 5B is a diagram for explaining contents that are displayed on the panel unit of the portable terminal in FIG. 1 related to reserving an MFP, and illustrates a reservation-complete screen (C) that is displayed when the reservation-management server on the store chain B side receives a reservation.

FIG. 6A is a diagram for explaining contents that are displayed on the panel unit of the portable terminal in FIG. 1 related to reserving an MFP, and illustrates a tentative-reservation screen (D) based on a notification from the reservation-management server in FIG. 1.

FIG. 6B is a diagram for explaining contents that are displayed on the panel unit of the portable terminal in FIG. 1 related to reserving an MFP, and similar to FIG. 6A, illustrates a tentative-reservation screen (D) based on a notification from the reservation-management server in FIG. 1.

FIG. 7A is a diagram for explaining contents that are displayed on the panel unit of the portable terminal in FIG. 1 related to reserving an MFP, and illustrates a tentative-reservation-complete screen (E) that is displayed when the reservation-management server on the store chain A side in FIG. 1 receives a tentative reservation.

FIG. 7B is a diagram for explaining contents that are displayed on the panel unit of the portable terminal in FIG. 1 related to reserving an MFP, and illustrates a tentative-reservation-complete screen (F) that is displayed when the reservation-management server on the store chain B side in FIG. 1 receives a tentative reservation.

FIG. 8 illustrates the steps of processing on the portable terminal side of the reservation-management system in FIG. 1.

FIG. 9 illustrates the steps of processing on reservation-management server side of the reservation-management system in FIG. 1.

### DETAILED DESCRIPTION

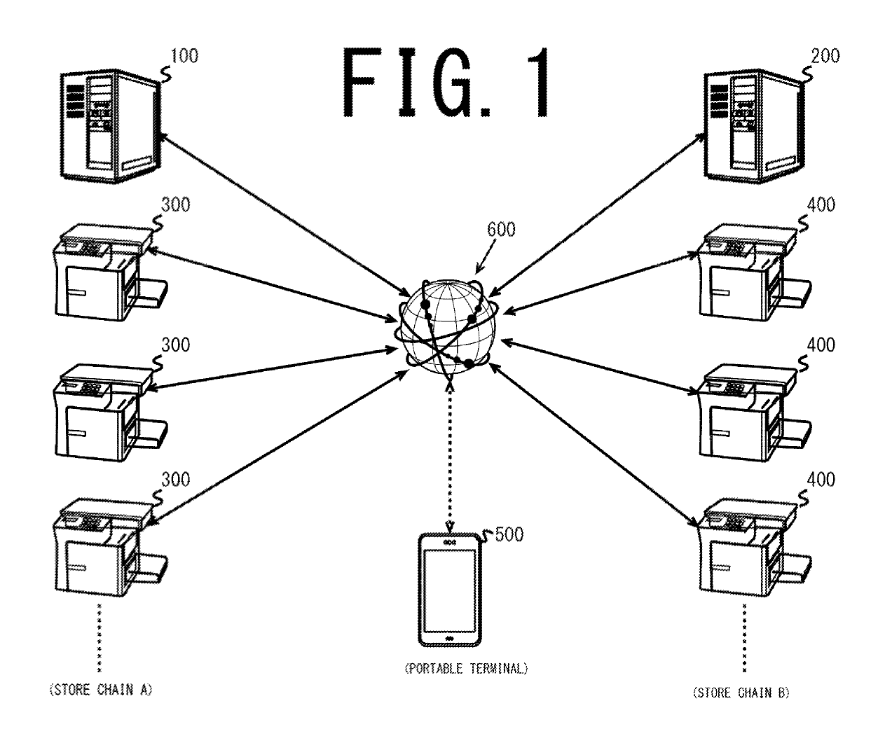

In the following, an embodiment of a reservation-management system according to the present disclosure will be explained with reference to FIG. 1 to FIG. 9. Incidentally, an MFP that is a complex peripheral device having a printing function, a copying function, a FAX function, a data transmitting/receiving function via a network, and the like will be presumed as an example of an image forming apparatus that is included in the reservation-management system in the explanation below.

First, as illustrated in FIG. 1, the reservation-management system includes reservation-management servers 100, 200, MFPs 300, 400, and a portable terminal 500. Moreover, the reservation-management servers 100, 200, the MFPs 300, 400, and the portable terminal 500 are connected via a network 600 such as the Internet or the like. Here, the MFPs 300 are installed in convenience stores that are in the store chain A, for example. Moreover, the MFPs 400 are installed in convenience stores that are in the store chain B, for example. The reservation-management server 100 manages reservations of the MFPs 300 in the store chain A. The reservation-management server 200 manages reservations of the MFPs 400 in the store chain B. In addition, as will be described in detail later, the reservation-management server 100 and the reservation-management server 200 are linked together and make it possible to perform tentative reservations of the MFPs 300 and the MFPs 400.

By making it possible to perform tentative reservations of the MFPs 300 and MFPs 400 in this way, even when, for example, a user that has a reservation is not on time to the reservation due to some circumstance (for example, traffic jam, late train, or the like) and the reservation is cancelled, it is possible to use a MFP 300 or MFP 400 without having to reserve a MFP 300 or MFP 400 again. Incidentally, FIG. 1 illustrates a case in which the reservation-management servers 100, 200 manage reservations of the MFPs 300 and 400, respectively, however, not being limited to this example, configuration is also possible in which there may be only one reservation-management server 100, 200 that manages reservations of each of the MFPs 300, 400. Moreover, FIG. 1 illustrates configuration that includes MFPs 300 in store chain A, and MFPs 400 in store chain B, however, it is not absolutely necessary to include MFPs 300, 400 of store chains In other words, any configuration is possible as long as the reservation-management servers can simply manage distributed MFPs 300, 400.

The portable terminal 500 is a tool for reserving an MFP 300 or MFP 400 via a network 600. The portable terminal 500, as will be explained later, is used to login to the reservation-management server 100 or reservation-management server 200 and make a reservation or tentative reservation of a MFP 300 or MFP 400. Moreover, when making a reservation or tentative reservation of the nearest MFP 300 or MFP 400, the portable terminal 500 transmits terminal-position information indicating the position of the portable terminal 500 to the reservation-management server 100 or reservation-management server 200. As a result, the reservation-management server 100 or reservation-management server 200 can notify the store where the nearest MFP 300 or MFP 400 is installed based on the terminal-position information from the portable terminal 500.

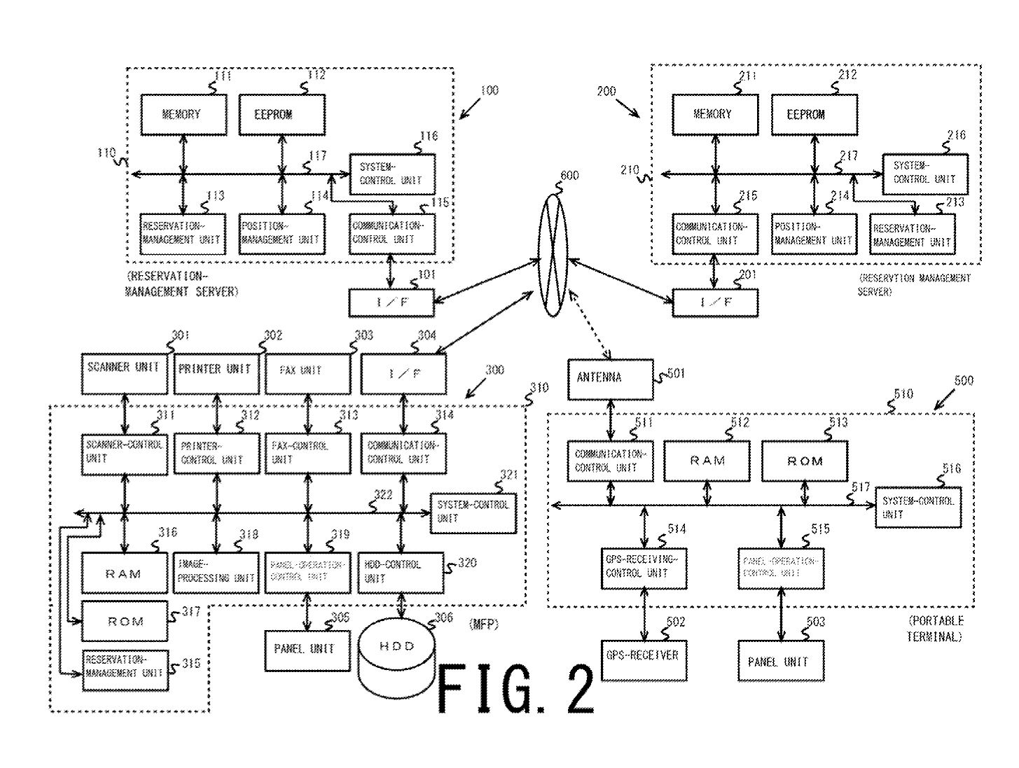

Next, an example of configuration of reservation-management servers 100, 200, MFPs 300, 400, and portable terminal 500 will be explained with reference to FIG. 2. Incidentally, the configuration of the MFPs 300, 400 are mostly the same, so a MFP 300 will be illustrated as a representative. Moreover, the reservation-management server 100 performs communication with the reservation-management server 200, the MFPs 300, and the portable terminal 500, however, does not perform communication with the MFPs 400 since the store chain is different. On the other hand, the reservation-management server 200 performs communication with the reservation-management server 100, the MFPs 400, and the portable terminal 500, however, does not perform communication with the MFPs 300 since the store chain is different.

In other words, the reservation-management server 100 (200) includes a control unit 110 (210) that controls an I/F 101 (201). The I/F 101 takes charge of communication with the reservation-management server 200, the MFPs 300 and the portable terminal 500 via a network 600. The I/F 201 takes charge of communication with the reservation-management server 100, the MFPs 400 and the portable terminal 500 via the network 600.

The control unit 110 (201) is a processor that controls the overall operations of the reservation server 100 (200) by executing application programs, control program and the like. The control unit 110 (210) includes a memory 111 (211), an EEPROM 112 (212), a reservation-management unit 113 (213), a position-management unit 114 (214), a communication-control unit 115 (215), and a system-control unit 116 (216). Moreover, these units are connected to a data bus 117 (217).

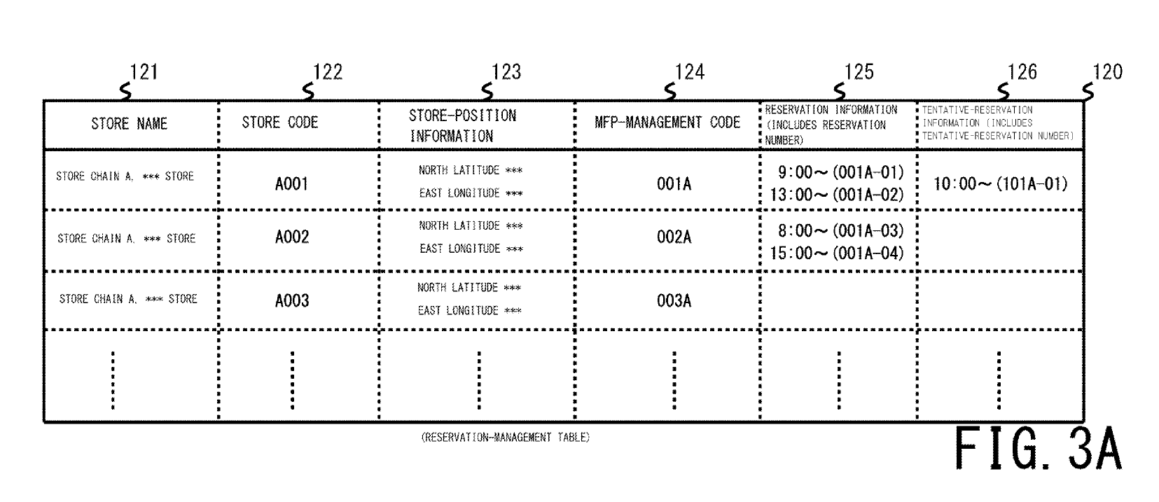

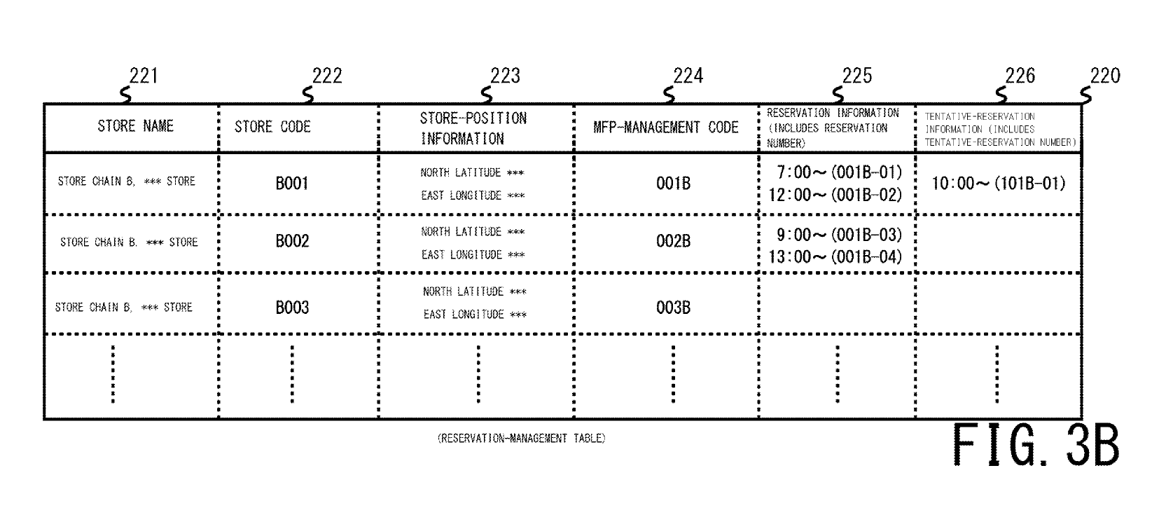

The memory 111 (211) is a work memory for executing programs. The EEPROM 112 (212) stores a control program for performing operation checks and the like of each unit. The reservation-management unit 113 manages reservations of MFPs 300 according to a reservation management table 120 as illustrated in FIG. 3A described later. The reservation-management unit 213 manages reservations of MFPs 400 according to a reservation management table 220 as illustrated in FIG. 3B described later. Incidentally, the reservation management table 120 (220) is presumed to be stored in the EEPROM 112 (212).

The position-management unit 114 (214) manages the position of the portable terminal 500 based on terminal-position information that is received from the portable terminal 500. The communication-control unit 115, via the I/F 101, performs control of transmitting data to and receiving data from the reservation-management server 200, MFPs 300 and portable terminal 500 via the network 600. The communication-control unit 215, via the I/F 201, performs control of transmitting data to and receiving data from the reservation-management server 100, MFPs 400 and portable terminal 500 via the network 600.

The system-control unit 116, via the communication-control unit 115, receives a login request from the portable terminal 500, then after user authentication, instructs the reservation-management unit 113 to perform reservation management. Moreover, the system-control unit 116 transmits the reservation time and reservation number in the reservation-information column 125 illustrated in FIG. 3A described later, or the tentative-reservation time and tentative-reservation number in the tentative-reservation-information column 126 to the MFP 300 corresponding to the MFP-management code (for example, 001A) in the MFP-management code column 124. Furthermore, for the reservation (or this reservation), the system-control unit 116 instructs the MFP 300 corresponding to the MFP-management code (for example, 001A) in the MFP-management code column 124 of the standby time restricting the use of the functions of the MFP 300 by other users before the start of the reservation time. The system-control unit 116, via the communication-control unit 215, receives a login request from the portable terminal 500, then after user authentication, instructs the reservation-management unit 213 to perform reservation management. Moreover, the system-control unit 216 transmits the reservation time and reservation number in the reservation-information column 225 illustrated in FIG. 3B described later, or the tentative-reservation time and tentative-reservation number in the tentative-reservation-information column 226 to the MFP 400 corresponding to the MFP-management code (for example, 001B) in the MFP-management code column 224. Furthermore, for the reservation (or this reservation), the system-control unit 216 instructs the MFP 400 corresponding to the MFP-management code (for example, 001B) in the MFP-management code column 224 of the standby time restricting the use of the functions of the MFP 400 by other users before the start of the reservation time.

However, for a tentative reservation, the system-control units 116, 216 do not give an instruction of the standby time restricting the use of functions of the MFP 300, 400 by other users.

Next, the MFP 300 includes a control unit 310 that controls the operation of a scanner unit 301, a printer unit 302, a FAX unit 303, an I/F (interface) 304, a panel unit 305 and a HDD 306.

The scanner unit 301 is a device that converts an image of a document that is read by an image sensor to digital image data, and inputs the image data to the control unit 310. The printer unit 302 is a device that prints images on paper based on printing data that is outputted from the control unit 310. The FAX unit 303 is a device that transmits data that is outputted from the control unit 310 to a facsimile of another party via telephone lines, and receives data from a facsimile of another party and inputs that data to the control unit 310.

The I/F 304, via the network 600, takes charge of communication with the reservation-management servers 100, 200, MFPs 400, the portable terminal 500, and the like. Incidentally, the I/F 304, via the network 600, may also take charge of communication with a content server, web server, and the like. The panel unit 305 is a device such as a touch panel that performs a display for the printing function, the copying function, the FAX function, the data transmitting/receiving function via network, and for various settings. Moreover, the panel unit 305 displays contents and the like for prompting input of a reservation number and the like. The HDD 306 is a storage device that stores application programs and the like for providing the various functions of the MFP 300. In addition, the HDD 306 has user boxes for storing registered printing jobs from the portable terminal 500 and the like.

The control unit 310 is a processor that controls the overall operations of the MFP 300 by executing application programs, an image-forming program, a control program and the like for the printing function, copying function, FAX function, data transmitting/receiving function via a network, and the like. The control unit 310 includes a scanner-control unit 311, a printer-control unit 312, a FAX-control unit 313, a communication-control unit 314, a reservation-management unit 315, a RAM 316, a ROM 317, an image-processing unit 318, a panel-operation-control unit 319, an HDD-control unit 320, and a system-control unit 321. Moreover, these units are connected to a data bus 322.

The scanner-control unit 311 controls the reading operation of the scanner unit 301. The printer-control unit 312 controls the printing operation of the printer unit 302. The FAX-control unit 313 controls the data transmitting/receiving operation by the FAX unit 303. The communication-control unit 314, via the I/F 304, performs control of transmitting/receiving data and the like via the network 600.

The reservation-management unit 315 manages the reservation times and reservation numbers that are received from the reservation-management server 100 in the reservation-information column 125 illustrated in FIG. 3A described later. The RAM 316 is a work memory for executing programs. Moreover, the RAM 316 stores printing data that has undergone image processing by the image-processing unit 318. The ROM 317 stores a control program for performing operation checks and the like of each unit. The image-processing unit 318 performs image processing (rasterization) on image data that is read by the scanner unit 301. Incidentally, the system-control unit 321 temporarily stores printing data that has undergone image processing by the image-processing unit 318 in the RAM 316.

The panel-operation-control unit 319 controls the display operation of the panel unit 305. Moreover, the panel-operation-control unit 319, via the panel unit 305, receives settings and the like for starting printing, copying, a FAX, transmitting or receiving data via network 600, and the like. Furthermore, the panel-operation-control unit 319, via the panel unit 305 receives input such as reservation numbers and the like. The HDD-control unit 320 controls, reading, writing and the like of data to and from the HDD 306.

The system-control unit 321 controls cooperative operation of each of the units and the like. Moreover, the system-control unit 321, according to an instruction from the reservation-management server 100, references the reservation times managed by the reservation-management unit 315, and sets the standby time that restricts use by other users before the start of the reservation time, and restricts the use of the functions of the MFP 300. In other words, when the reservation time is 9:00 for example, at 5 minutes before (8:55), the reservation-management unit 315 restricts use of the functions of the MFP 300. In this case, the system-control unit 321, via the panel-operation-control unit 319, displays on the panel unit 305, for example, that use is restricted. Moreover, at the reservation time, the system-control unit 321 continues to restrict use of the MFP 300. In addition, after the start of the reservation time, when the user that reserved the MFP 300 finishes using the MFP 300, the system-control nit 321 releases restriction of use of the MFP 300, and notifies the reservation-management server 100 that reserved usage is finished. Incidentally, the system-control unit 321, by comparing a reservation number that is inputted via the panel unit 305 with a reservation number that is managed by the reservation-management unit 315, determines whether or not the user is the user that reserved the MFP 300. In addition, when use of the MFP 300 has not been performed by the user that reserved the MFP 300 even though a set amount of time (for example, 10 minutes) has elapsed from the reservation time, the system-control unit 321 cancels the reservation of the MFP 300, and releases restrictions of use of the MFP 300. As a result, use of the MFP 300 by other users becomes possible, and a decrease in the availability of the MFP 300 is suppressed, Moreover, when use of the MFP 300 has not been performed by the user that reserved the MFP 300 even though a fixed amount of time (for example, 10 minutes) has elapsed from the reservation time, the system-control unit 321 notifies the reservation-management server 100 that the reservation has been cancelled. As a result, as will be described in more detail later, in addition to notifying the portable terminal 500 that the reservation is cancelled, the system-control unit notifies the portable terminal 500 of contents prompting the making of a tentative reservation. Furthermore, the system-control unit 321 does not restrict the use of the MFP 300 by other users in accordance to the tentative reservation time of the tentative reservation.

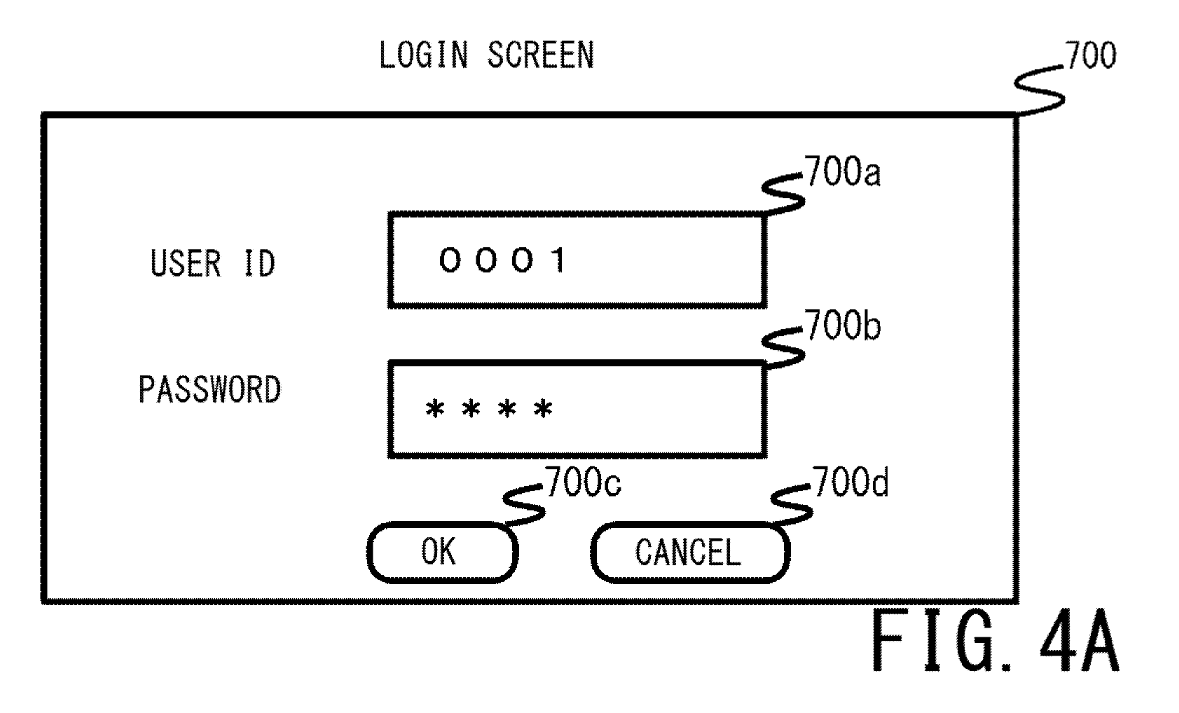

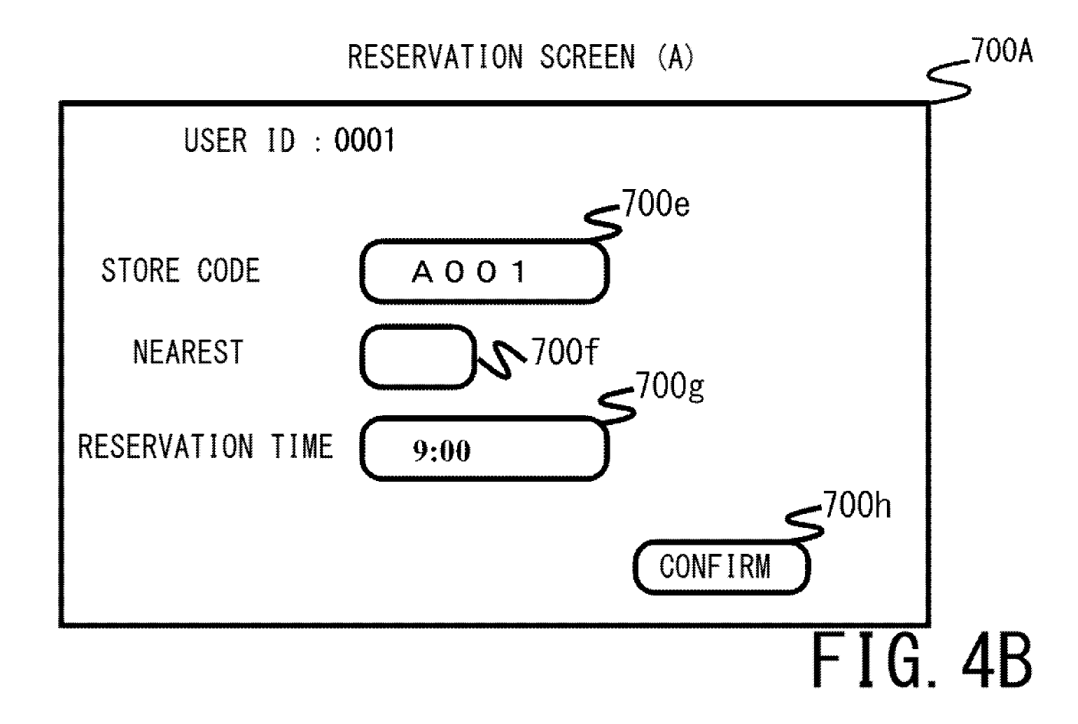

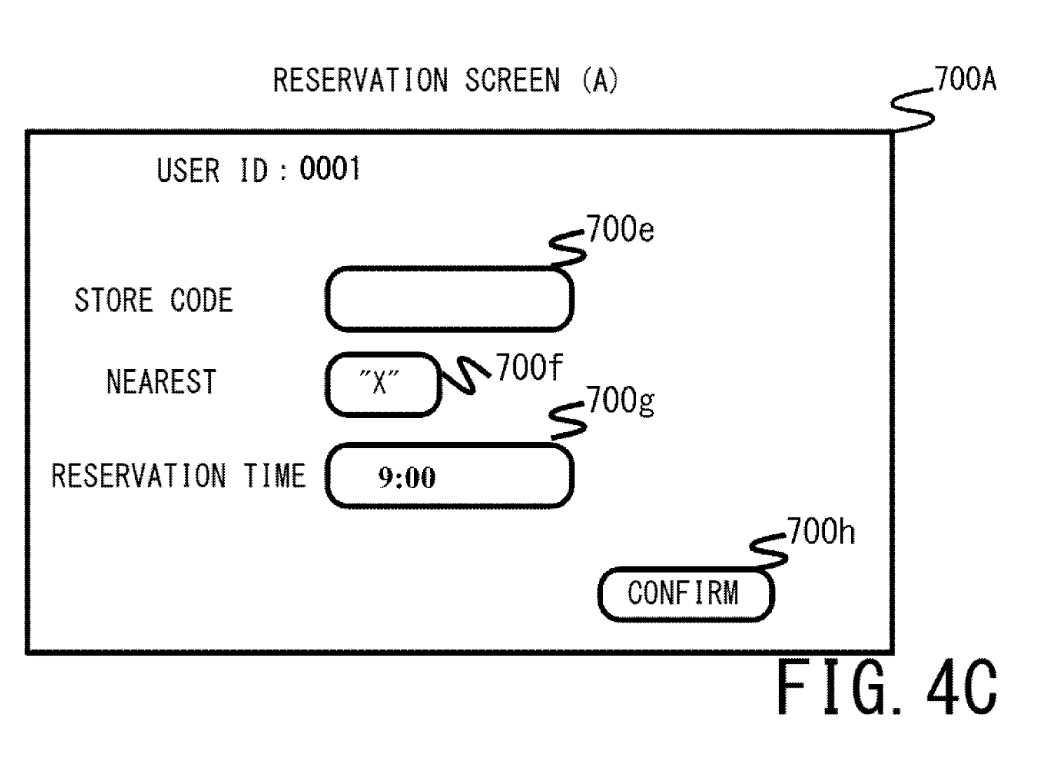

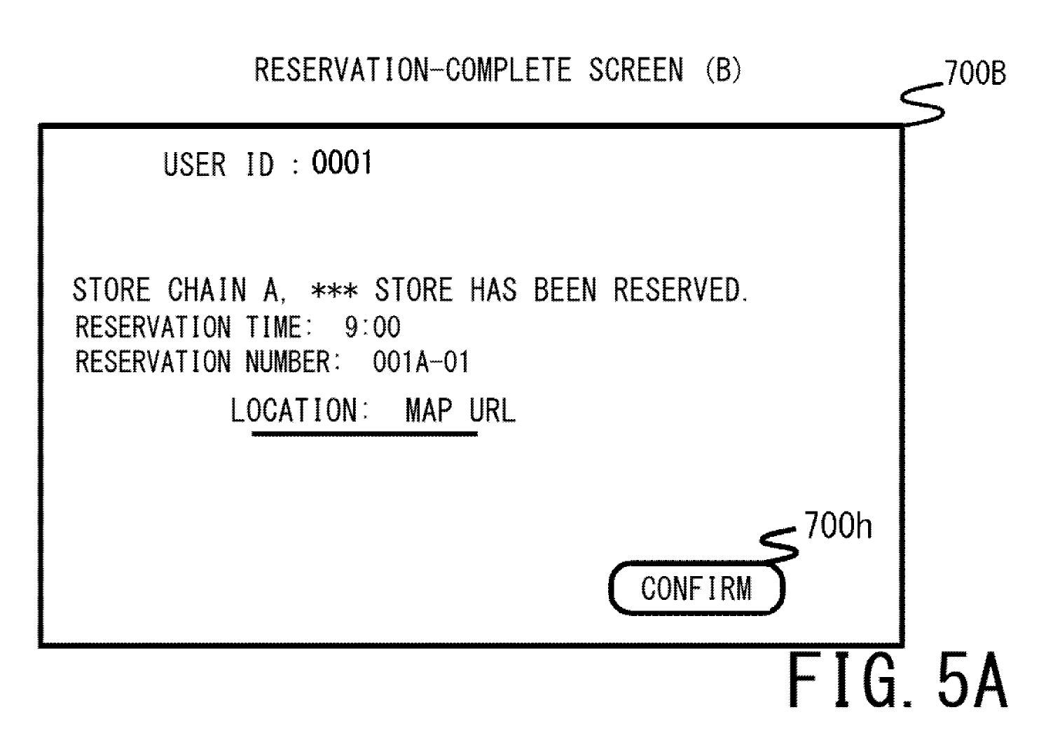

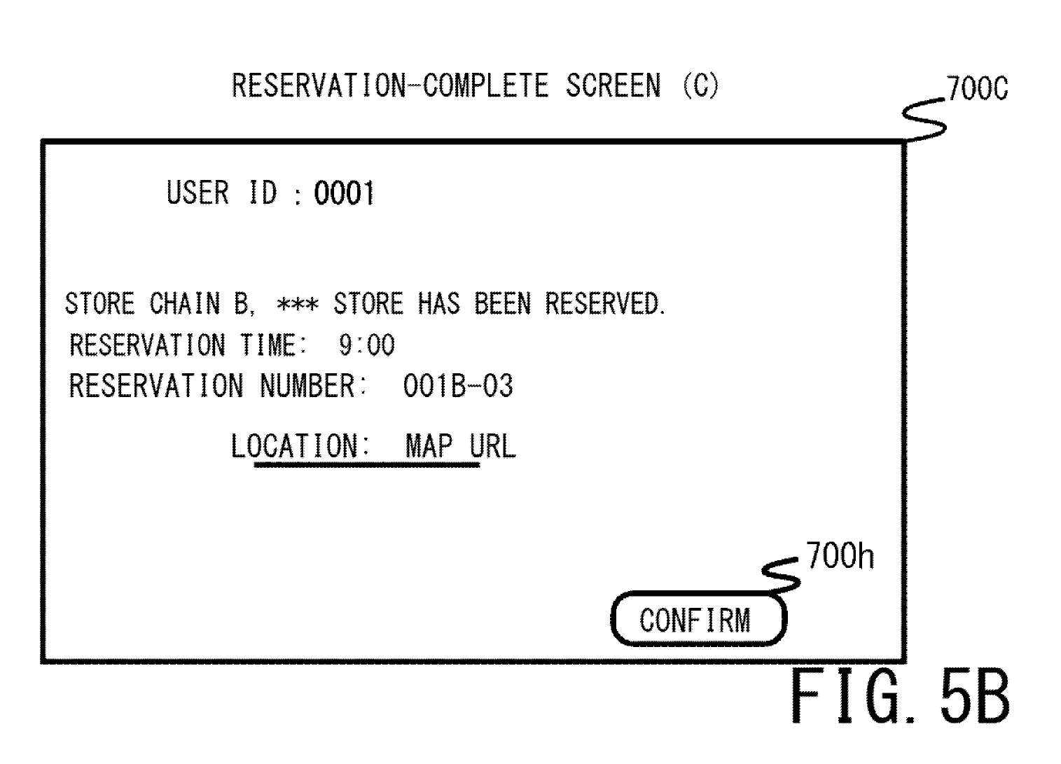

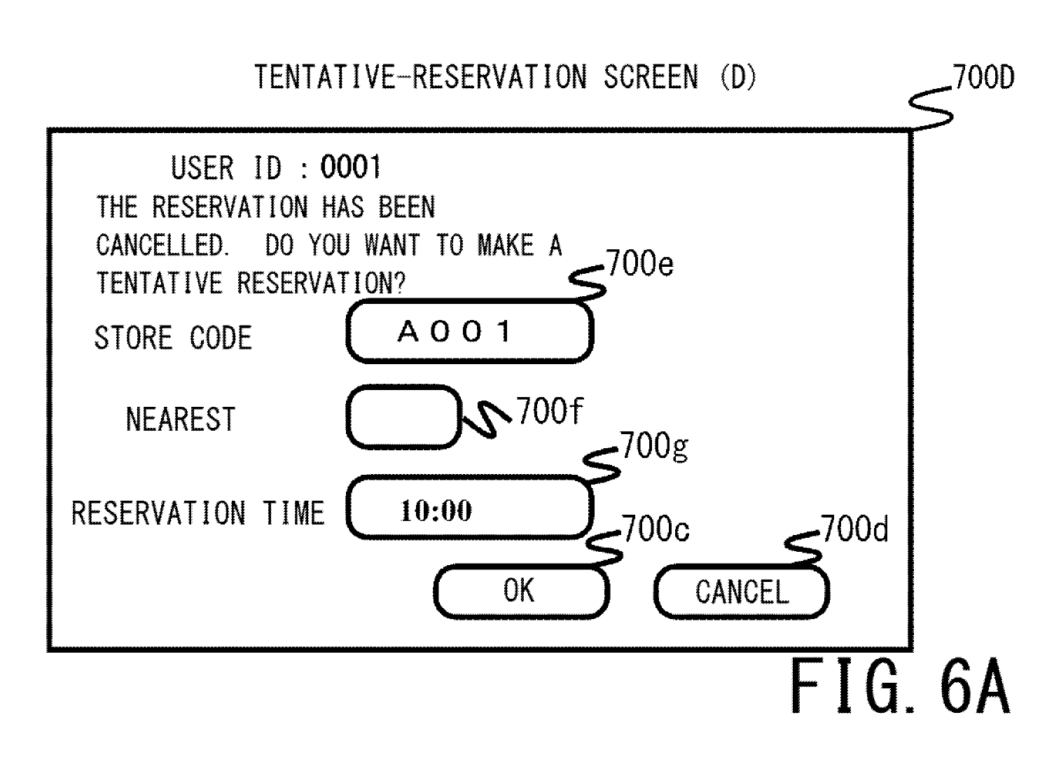

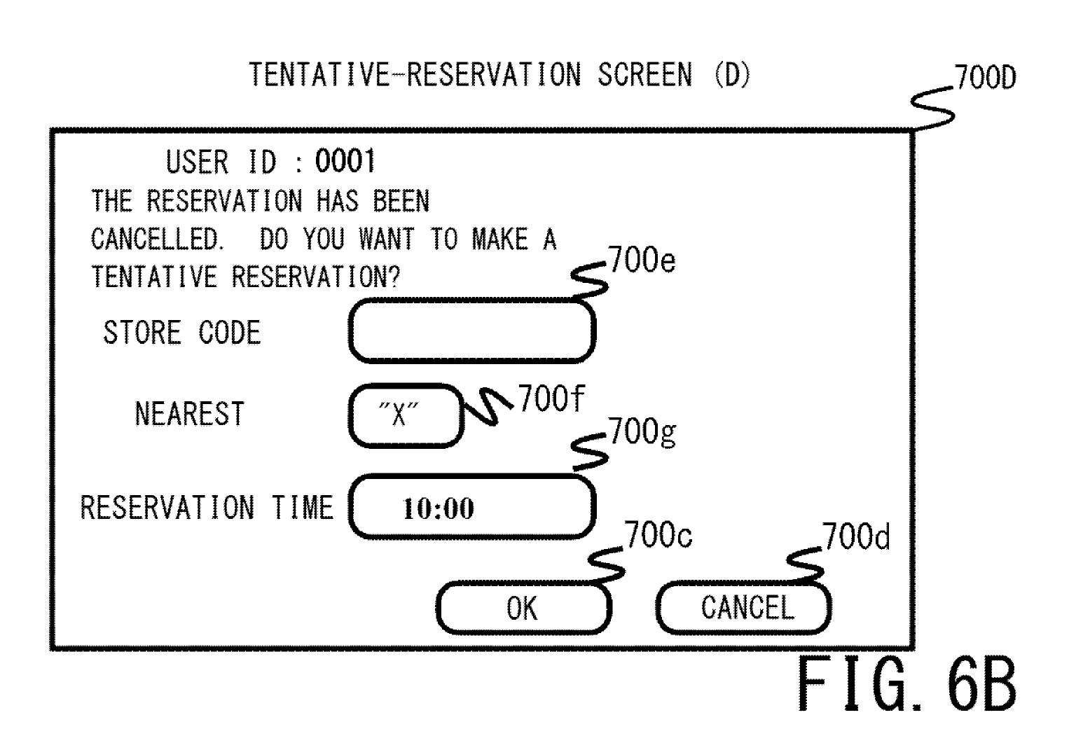

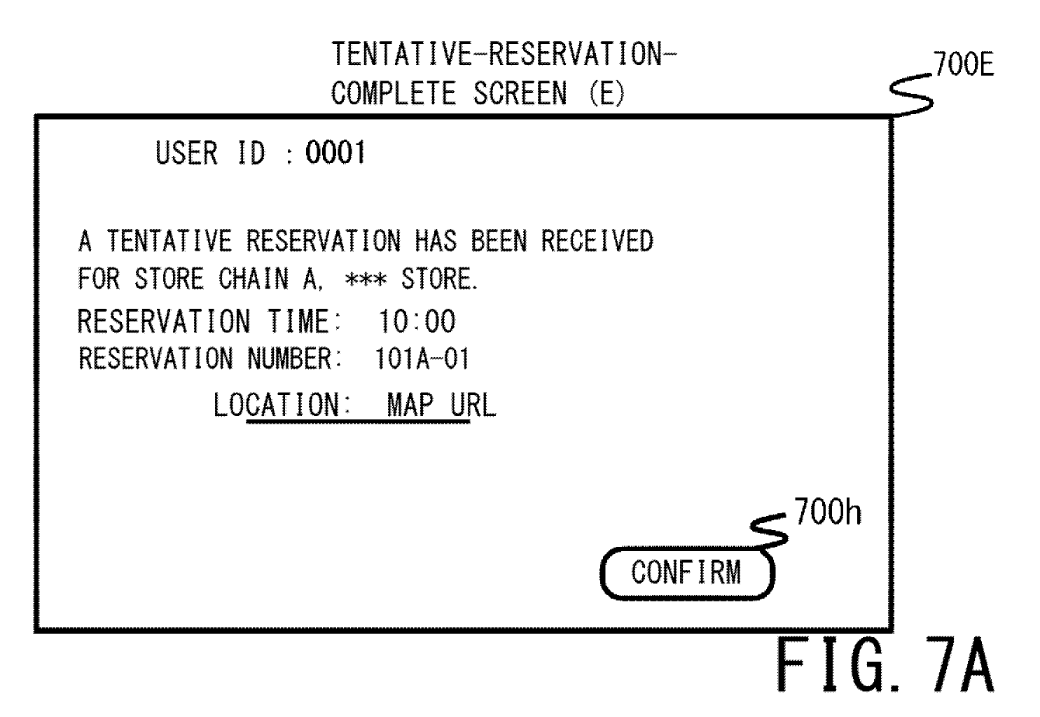

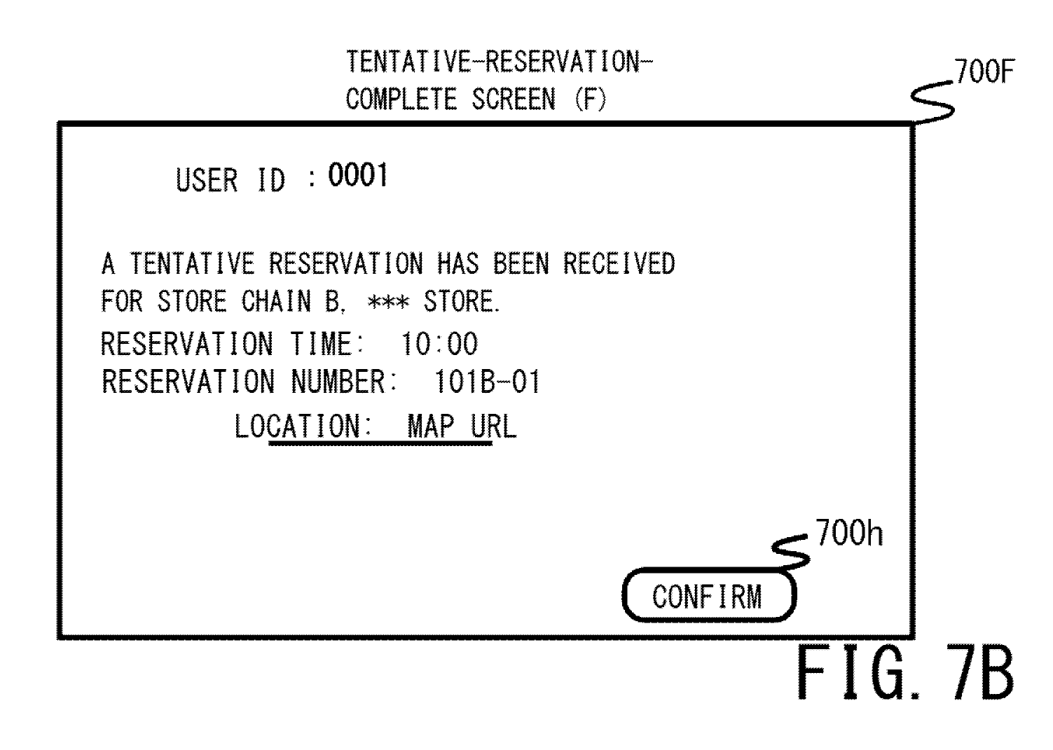

Next, the portable terminal 500 includes a control unit 510 that controls an antenna 501, a GPS receiver 502, and a panel unit 503. The antenna 501, via a wireless base station and the network 600, takes charge of communication with the reservation-management servers 100, 200, the MFPs 300, 400, and the like. In addition, the antenna 501, via the wireless base station, takes charge of communication with a content server, web server and the like via the network 600. The GPS receiver 502 receives radio signals from a satellite and acquires terminal-position information. The panel unit 503 is a device such as a touch panel and the like for performing the selection of various functions of the portable terminal 500, the input of characters, the display of information, and the like. In addition, the panel unit 503 displays a login screen 700 as illustrated in FIG. 4A described later, a reservation screen (A) 700A as illustrated in FIGS. 4B and 4C, a reservation-complete screen (B) 700B and a reservation-complete screen (C) as illustrated in FIGS. 5A and 5B, a tentative-reservation screen (D) 700D as illustrated in FIGS. 6A and 6B, a tentative-reservation-complete screen (E) 700E and a tentative-reservation-complete screen (F) 700F as illustrated in FIGS. 7A and 7B, and the like.

The control unit 510 is a processor that controls the overall operation of the portable terminal 500 by executing application programs, a control program, and the like. The control unit 510 includes a communication-control unit 511, a RAM 512, a ROM 513, a GPS-receiving-control unit 514, panel-operation-control unit 515, and a system-control unit 516. Moreover, these units are connected to a data bus 517.

The communication-control unit 511, via the antenna 501 and via the wireless base station, performs control of transmitting and receiving data to and from the reservation-management servers 100, 200 via the network 600. The RAM 512 is a work memory for executing programs. The ROM 513 stores a control program for performing operation checks and the like of each unit. The GPS-receiving-control unit 514 controls the reception by the GPS receiver 502 or the like from the satellite. The panel-operation-control unit 515 controls the display operation and the like of the panel unit 503.

The system-control unit 516 controls cooperative operation and the like of each of the units. Moreover, when there is a login request via the panel unit 503 to login to the reservation-management server 100 or 200, the system-control unit 516 causes the panel-operation-control unit 515 to receive input of a user ID and password that are necessary for the login request. In addition, after login to the reservation-management server 100 or 200 and a reservation for a MFP 300 or MFP 400 is complete, the system-control unit 516, via the communication-control unit 511, transmits the terminal-position information received by the GPS receiver 502 to the reservation-management server 100 or 200.

Next, the reservation management tables 120, 220 that are managed by the reservation-management servers 100, 200 will be explained with reference to FIGS. 3A and 3B. First, FIG. 3A illustrates a reservation-management table 120 that is managed by the reservation-management unit 113 of the reservation-management server 100. The reservation-management table 120 is provided with a store-name column 121, a store-code column 122, a store-position-information column 123, an MFP-management-code column 124, a reservation-information column 125, a tentative-reservation-information column 126 and the like. Store names of stores in store chain A are registered in the store-name column 121. Store codes that are assigned for each store of store chain A are registered in the store-code column 122. By using the store code, it is easy to reserve a MFP 300 with the portable terminal 500. Store-position information that indicates the coordinates (north latitude and east longitude) on a map, for example, is registered in the store-position-information column 123. By using this store-position information, it is possible to cause the portable terminal 500 to display the position of a store on a map. MFP-management code that is assigned to the MFP 300 installed at each of the stores in the store chain A is registered in the MFP-management-code column 124. The reserved reservation times and reservation numbers are registered in the reservation-information column 125. The tentatively reserved tentative-reservation times and tentative-reservation numbers are registered in the tentative-reservation-information column 126. The reservation-management servers 100, 200 restrict reservations and tentative reservations from being made by other users at the same time as a tentative reservation time.

FIG. 3B illustrates a reservation-management table 220 that is managed by the reservation-management unit 213 of the reservation-management server 200. The reservation-management table 220, similar to the reservation-management table 120, is provided with a store-name column 221, a store-code column 222, a store-position-information column 223, an MFP-management-code column 224, a reservation-information column 225, a tentative-reservation-information column 226 and the like. Store names of stores in store chain B are registered in the store-name column 221. Store codes that are assigned for each store of store chain B are registered in the store-code column 222. As described above, by using the store code, it is easy to reserve a MFP 400 with the portable terminal 500. Store-position information that indicates the coordinates (north latitude and east longitude) on a map, for example, is registered in the store-position-information column 223. As described above, by using this store-position information, it is possible to cause the portable terminal 500 to display the position of a store on a map. MFP-management code that is assigned to the MFP 400 installed at each of the stores in the store chain B is registered in the MFP-management-code column 224. The reserved reservation times and reservation numbers are registered in the reservation-information column 225. The tentatively reserved tentative-reservation times and tentative-reservation numbers are registered in the tentative-reservation-information column 226. The reservation-management servers 100, 200 restrict reservations and tentative reservations from being made by other users at the same time as a tentative reservation time.

Next, contents related to reserving a MFP 300, 400 that are displayed on the panel unit 503 of the portable terminal 500 will be explained with reference to FIG. 4A to FIG. 7B. First, FIG. 4A illustrates a login screen when making a login request to the reservation-management server 100, for example. Incidentally, the login screen 700 also has the same contents when making a login request to the reservation-management server 200. An input field 700a for inputting a user ID, an input field 700b for inputting a password, an OK button 700c, and a Cancel button 700d are displayed on the login screen 700. A user ID (for example, 0001) that is assigned beforehand by the reservation-management server 100 or 200, when a user registers, is inputted in the input field 700a. A password (****) that is assigned beforehand by the reservation-management server 100 or 200, when a user registers, is inputted in the input field 700b. The password can be arbitrarily changed. The OK button 700c is touch operated when setting the contents in the input fields 700a, 700b. Moreover, when the OK button 700c is touch operated, the system-control unit 516 sends a login request to the reservation-management server 100, for example. The cancel button 700d is touch operated when closing the login screen 700.

The FIG. 4B illustrates a reservation screen (A) 700A that is displayed on the panel unit 503 when user authentication is successful on the reservation-management server 100 side, for example. An input field 700e for inputting a store code (for example A001) as illustrated in FIG. 3A, for example, an input field 700f for inputting a check when selecting “Nearest”, an input field 700g for inputting the reservation time, and a Confirm button 700h are displayed on the reservation screen (A) 700A. A store code (for example, A001) is inputted in the input field 700e. When a store code (for example, A001) is inputted in the input field 700e, it is not necessary to input a check in the input field 700f. A reservation time (for example, 9:00) is inputted in the input field 700g. The Confirm button 700h is touch operated when confirming the contents of the reservation that is inputted in input fields 700e, 700g. Moreover, when the Confirm button 700h is touch operated, the system-control unit 516 transmits the contents of the reservation that is inputted in input fields 700e, 700g to the reservation-management server 100, for example, and requests a reservation.

The system-control unit 116 of the reservation-management server 100, based on a reservation request, searches for a store corresponding to the store code that is included in the reservation contents, and receives a reservation for the reservation time for the store that was identified by the search. The system-control unit 116 notifies the portable terminal 500 that a reservation has been received.

Then, after a reservation is received on the reservation-management server 100 side, the system-control unit 516, via the panel-operation-control unit 515, causes the panel unit 503 to display a reservation-complete screen (B) 700B as illustrated in FIG. 5A. Moreover, when it is not possible to receive a reservation on the reservation-management server 100 side (there is already a reservation or the like), the system-control unit, via the panel-operation-control unit 515, causes the panel unit 503 to display contents indicating that a reservation cannot be made. Incidentally, when a store code is inputted in the input field 700e, it is also possible to perform a pop-up display of the vacant times (times for which there are no reservations) for the MFP 300 corresponding to the store code.

Moreover, when a check is inputted in the input field 700f when a store code is not inputted in the input field 700e, it is possible to display a “X” mark in the input field 700f as in the reservation screen (A) 700 illustrated in FIG. 4C. In this case, by placing the finger tip on the input field 700f, the “X” mark may be selected by a pop-up display.

FIG. 5A illustrates a reservation-complete screen (B) 700B that is displayed on the panel unit 503 when a reservation is received on the reservation-management server 100 side, for example. The contents of the reservation and a Confirm button 700h are displayed on the reservation-complete screen (B) 700B. The reservation contents may include the store name, the reservation time (for example, 9:00), the reservation number (for example, 001A-01), a map URL indicating the location of the store (webp age address that displays a map) of the store in the store chain A that took the reservation, and the like. Here, when the map URL is touch operated, a map indicating the location of the store that took the reservation is displayed on the panel unit 503. Incidentally, the map that is displayed on the panel unit 503 may display the distance from the current location and the estimated time of arrival by walking, estimated time of arrival by bicycle, estimated time of arrival by automobile, and the like. Moreover, when the Confirm button 700h is touch operated, the reservation-complete screen (B) 700B may change to a standby screen, for example.

FIG. 5B illustrates a reservation-complete screen (C) 700C that is displayed on the panel unit 503 when a check is inputted in the input filed 700f specifying “Nearest” as in the reservation screen (A) in FIG. 4C and a reservation is received on the reservation-management server 200 side. In other words, the reservation-management server 100 and the reservation-management server 200 are linked, so even though a login request is sent from the portable terminal 500 to the reservation-management server 100, the case is presumed in which the store that is nearest to the position obtained from the terminal-position information from the portable terminal 500 is a store in the store chain B that is managed by the reservation-management server 200. The reservation contents and a Confirm button 700h are displayed on this reservation-complete screen (C) 700C. The reservation contents may include the store name, the reservation time (for example, 9:00), the reservation number (for example, 001B-03), a map URL indicating the location of the store (webp age address that displays a map) of the store in the store chain B that took the reservation, and the like. Here, when the map URL is touch operated, a map indicating the location of the store that took the reservation is displayed on the panel unit 503. Incidentally, as described above, the map that is displayed on the panel unit 503 may display the distance from the current location and the estimated time of arrival by walking, estimated time of arrival by bicycle, estimated time of arrival by automobile, and the like. Moreover, when the Confirm button 700h is touch operated, the reservation-complete screen (C) 700C may change to a standby screen, for example.

FIG. 6A illustrates a tentative-reservation screen (D) 700D that is displayed on the panel unit 503 of the portable terminal 500 based on a notification from the reservation-management server 100, for example, when a user missed the reservation time. In addition to cancellation contents and contents prompting the making of a tentative reservation from the reservation-management server 100, for example, an input field 700e for inputting a store code (for example, A001) as illustrated in FIG. 3A for example, an input field 700f for inputting a check when selecting “Nearest”, an input field 700g for inputting a reservation time, an OK button 700c and a Cancel button 700d are displayed on the tentative-reservation screen (D) 700D. A store code (for example, A001) is inputted in the input field 700e. When a store code (for example, A001) is inputted in the input field 700e, it is not necessary to input a check in the input field 700f. A reservation time (for example, 10:00) is inputted in the input field 700g. The OK button 700c is touch operated when setting the contents of the tentative reservation that is inputted in the input fields 700e, 700g. Moreover, when the Confirm button 700h is touch operated, the system-control unit 516 transmits the contents of the tentative reservation that are inputted in the input fields 700e, 700g to the reservation-management server 100, for example. Incidentally, when the Cancel butting 700d is touch operated, the system-control unit 516 notifies the reservation-management server 100, for example, of a cancellation and that a tentative reservation will not be performed.

Then, when a tentative reservation is received on the reservation-management server 100 side, the system-control unit 516, via the panel-operation-control unit 515, causes the panel unit 503 to display a tentative-reservation-complete screen (E) 700E as illustrated in FIG. 7A described later. Incidentally, when a check is inputted in the input field 700f without inputting a store code in the input field 700e, an “X” mark is inputted in the input field 700f as on the tentative-reservation screen (D) 700D illustrated in FIG. 6B. In this case, the system-control unit 516, via the panel-operation-control unit 515, causes the panel unit 503 to display a tentative-reservation-complete screen (F) 700F as illustrated in FIG. 7B described later. Incidentally, in the case of the tentative-reservation-complete screen (F) 700F illustrated in FIG. 7B described later, the reservation-management server 100 and the reservation-management server 200 are linked, so even though a login request is sent from the portable terminal 500 to the reservation-management server 100, the case is presumed in which the store that is nearest to the position obtained from the terminal-position information from the portable terminal 500 is a store in the store chain B that is managed by the reservation-management server 200.

FIG. 7A illustrates a tentative-reservation-complete screen (E) 700E that is displayed on the panel unit 503 when a tentative reservation is received on the reservation-management server 100 side, for example. Contents of the tentative reservation and a Confirm button 700h are displayed on the tentative-reservation-complete screen (E) 700E. The tentative-reservation contents may include the store name of a store in the store chain A that took the tentative reservation, the tentative-reservation time (for example, 10:00), the tentative-reservation number (for example, 101A-01), a map URL indicating the location of the store (webpage address that displays a map), and the like. Here, when the map URL is touch operated, a map indicating the location of the store that took the tentative reservation is displayed on the panel unit 503. Incidentally, the map that is displayed on the panel unit 503 may display the distance from the current location and the estimated time of arrival by walking, estimated time of arrival by bicycle, estimated time of arrival by automobile, and the like. Moreover, when the Confirm button 700h is touch operated, the system-control unit 516 notifies the reservation-management server 100 that a tentative reservation has been confirmed. The system-control unit 116 of the reservation-management server 100 changes the tentative reservation to a real reservation, and causes the reservation-management unit 113 to manage the reservation. Then, the portable terminal 500 displays a reservation-complete screen on the panel unit 503 in the same way as displaying the same reservation-complete screen (B) illustrated in FIG. 5A.

FIG. 7B illustrates a tentative-reservation-complete screen (F) 700F that presumes a case in which even though the portable terminal 500 sends a login request to the reservation-management server 100, the reservation-management server 100 and the reservation-management server 200 are linked in the same way as described above, so the store that is nearest the position that is obtained from the terminal-position information from the portable terminal 500 is a store in the store chain B that is managed by the reservation-management server 200. The contents of the tentative reservation and a Confirm button 700h are displayed on the tentative-reservation-complete screen (F) 700F. The tentative-reservation contents may include the store name of a store in the store chain B that took the tentative reservation, the tentative-reservation time (for example, 10:00), the tentative-reservation number (for example, 101B-01), a map URL indicating the location of the store (webpage address that displays a map), and the like. Here, when the map URL is touch operated, a map indicating the location of the store that took the tentative reservation is displayed on the panel unit 503. Incidentally, the map that is displayed on the panel unit 503 may display the distance from the current location and the estimated time of arrival by walking, estimated time of arrival by bicycle, estimated time of arrival by automobile, and the like. Moreover, when the Confirm button 700h is touch operated, the system-control unit 516 notifies the reservation-management server 100 that a tentative reservation has been confirmed. The system-control unit 116 of the reservation-management server 100 notifies the reservation-management server 200 that a tentative reservation is set. The system-control unit 216 of the reservation-management server 200 changes the tentative reservation to a real reservation, and causes the reservation-management unit 213 to manage the reservation. Then, as described above, the portable terminal 500 displays a reservation-complete screen on the panel unit 503 in the same way as displaying the same reservation-complete screen (C) illustrated in FIG. 5B.

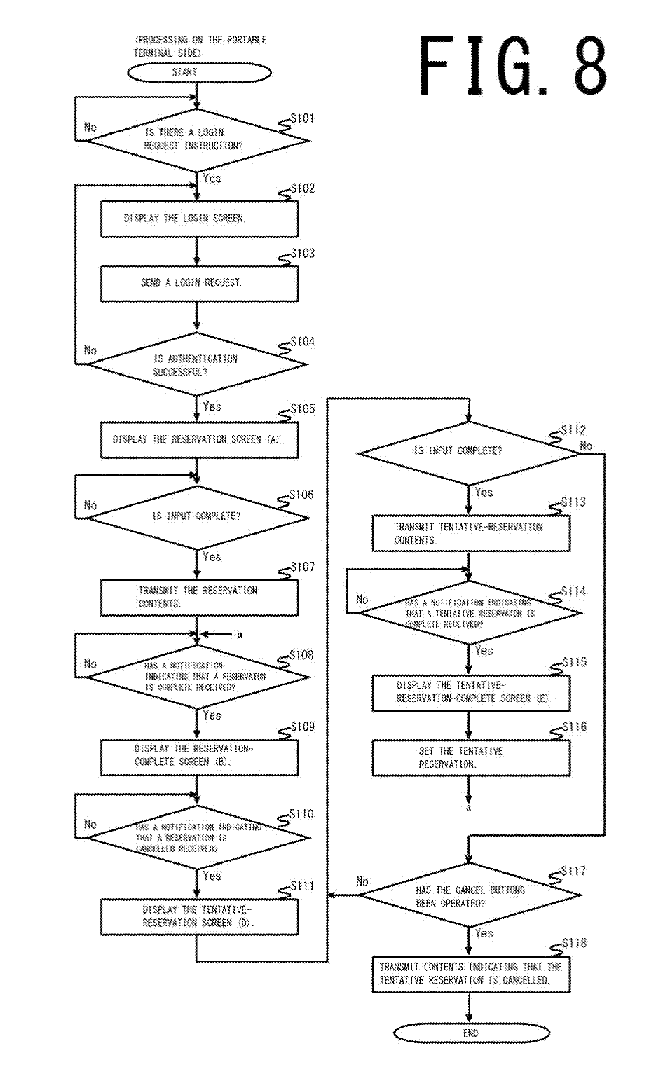

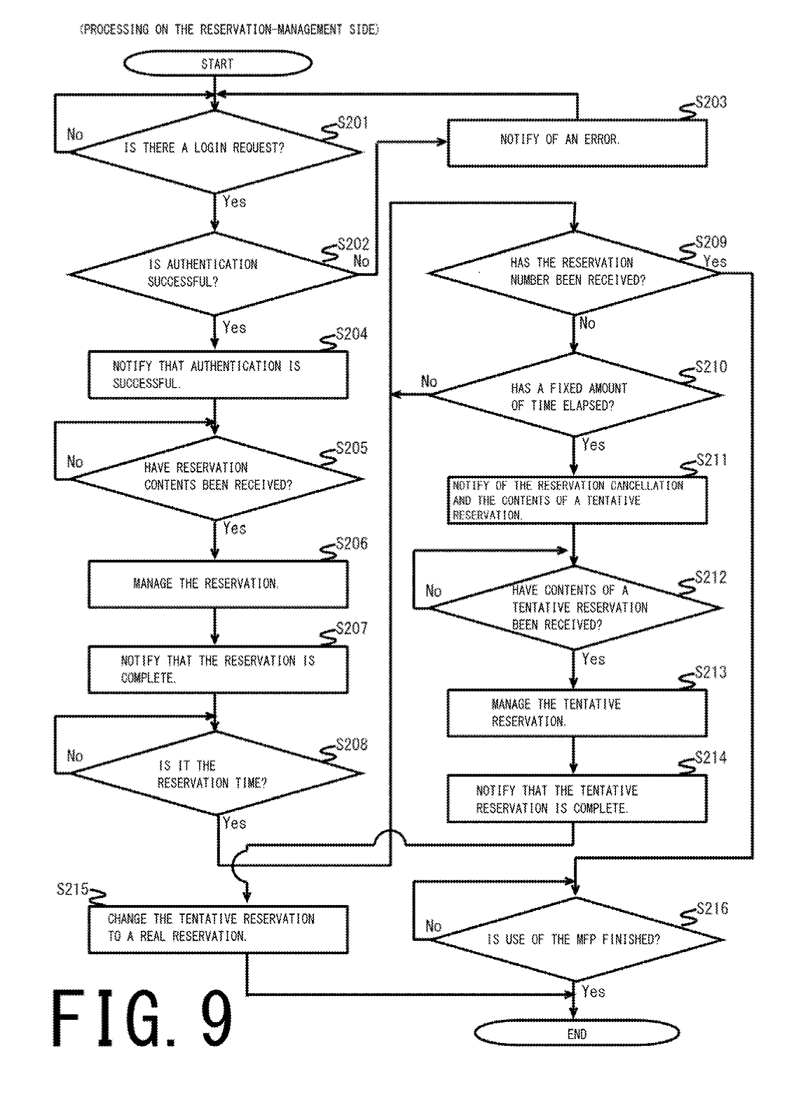

Next, the reservation-management process by the reservation-management system will be explained with reference to FIG. 8 and FIG. 9. First, processing on the portable terminal 500 side will be explained using FIG. 8. Incidentally, in the following explanation, the case will be explained in which a MFP 300 at a store of the store chain A, for example, is reserved using the portable terminal 500. Moreover, in the following explanation, the case will be explained in which information indicating vacant times of the MFPs 300 at each store is acquired.

### (Step S101)

The system-control unit 516 determines whether or not there is an instruction for a login request.

In this case, when there is no notification indicating that there is an instruction for a login request from the panel-operation-control unit 515 via the panel unit 515, the system-control unit 516 determines that there is no instruction for a login request (step S101: NO).

However, when there is a notification indicating that there is an instruction for a login request from the panel-operation-control unit 515 via the panel unit 515, the system-control unit 516 determines that there is an instruction for a login request (step S101: YES), and processing moves to step S102.

### (Step S102)

The system-control unit 516 causes a login screen 700 to be displayed.

In this case, the system-control unit 516, via the panel-operation-control unit 515, causes the panel unit 503 to display the login screen 700 illustrated in FIG. 4A.

Here, after the user inputs a user ID in the input field 700a of the login screen 700, inputs a password in input field 700b, and touch operates the OK button 700c, the login operation is complete.

### (Step S103)

The system-control unit 516 sends a login request.

In this case, after receiving a notification from the panel-operation-control unit 515 indicating that the OK button 700c has been touch operated, the system-control unit 516, via the communication-control unit 511, sends a login request to the reservation-management server 100.

### (Step S104)

The system-control unit 516 determines whether or not authentication is successful.

In this case, when the system-control unit 516, via the communication-control unit 511, receives a notification from the reservation-management server 100 indicating that authentication is not successful, the system-control unit 516 determines that authentication is not successful (step S104: NO), and processing returns to step S102.

Here, the system-control unit 516, via the panel-operation-control unit 515, causes the panel unit 503 to display an error indicating that authentication is not successful, then returns to step S102 again, causes input on the login screen 700 to be performed, and sends a login request again in step S103.

However, when the system-control unit 516, via the communication-control unit 511, receives a notification from the reservation-management server 100 indicating that authentication is successful, the system-control unit 516 determines that authentication is successful (step S104: YES), and processing moves to step S105.

### (Step S105)

The system-control unit causes the reservation screen (A) 700A to be displayed.

In this case, the system-control unit 516, via the panel-operation-control unit 515, causes the panel unit 503 to display the reservation screen (A) 700A that is illustrated in FIG.4B.

Here, the user inputs a store code (for example, A001) in the input field 700e, inputs the reservation time (for example, 9:00) in the input field 700g, and touch operates the Confirm button 700h.

Moreover, when making a reservation for the nearest store, the user inputs a check (for example, a “X” mark) in the input field 700f on the reservation screen (A) 700A illustrated in FIG. 4C, inputs the reservation time (for example, 9:00) in the input field 700g, and touch operates the Confirm button 700h.

### (Step S106)

The system-control unit 516 determines whether or not input is complete.

In this case, when there is no notification from the panel-operation-control unit 515 indicating that there was touch operation of the Confirm button 700h on the panel unit 503, the system-control unit 516 determines that input is not complete (step S106: NO).

However, when there is a notification from the panel-operation-control unit 515 indicating that there was touch operation of the Confirm button 700h on the panel unit 503, the system-control unit 516 determines that input is complete (step S106: YES), and processing moves to step S107.

### (Step S107)

The system-control unit 516 transmits the reservation contents.

In this case, the system-control unit 516 transmits the contents of the reservation inputted on the reservation screen (A) 700A in FIG. 4B to the reservation-management server 100.

Incidentally, in step S105, when a check (for example, a “X” mark) is inputted in the input field 700f for selecting “Nearest” on the reservation screen (A) 700A in FIG. 4C, the system-control nit 516 transmits the contents of the reservation inputted on the reservation screen (A) 700A in FIG. 4C to the reservation-management server 100. In this case, the system-control unit 516, via the GPS-receiving-control unit 514, controls the GPS receiver 502, and transmits terminal-position information that is acquired by the GPS receiver 502 to the reservation-management server 100.

### (Step S108)

The system-control unit 516 determines whether or not a notification indicating that the reservation is complete has been received.

In this case, when the communication-control unit 511 has not received a notification indicating that the reservation is complete, the system-control unit 516 determines that a notification indicating that the reservation is complete has not been received (step S108: NO).

However, when the communication-control unit 511 has received a notification indicating that the reservation is complete, the system-control unit 516 determines that a notification indicating that the reservation is complete has been received (step S108: YES), and processing moves to step S109).

### (Step S109)

The system-control unit 516 causes a reservation-complete screen (B) 700B to be displayed.

In this case, the system-control unit 516, via the panel-operation-control unit 515, causes the panel unit 503 to display the reservation-complete screen (B) 700B illustrated in FIG. 5A.

Incidentally, in step S105, when a check (for example, a “X” mark) is inputted in the input field 700f for selecting “Nearest” as on the reservation screen (A) 700A in FIG. 4C, and the reservation contents on the reservation screen (A) 700A in FIG. 4C are transmitted in step S107, the system-control nit 516, via the panel-operation-control unit 515, causes the panel unit 503 to display the reservation-complete screen (C) 700C illustrated in FIG. 5B, for example. This is because, as described above, even though the portable terminal 500 sends a reservation to the reservation-management server 100, the reservation-management server 100 and the reservation-management server 200 are linked, so a case is presumed in which the store that is nearest to the position obtained from the terminal-position information from the portable terminal 500 is a store in the store chain B that is managed by the reservation-management server 200.

### (Step S110)

The system-control unit 516 determines whether or not a notification has been received indicating a cancellation of a reservation.

In this case, when the communication-control unit 511 has not received a notification from the reservation-management server 100 indicating that a user was not able to make it on time for the reservation time, the system-control unit 516 determines that a notification indicating a cancellation of a reservation has not been received (step S110: NO).

However, when the communication-control unit 511 has received a notification from the reservation-management server 100 indicating that a user was not able to make it on time for the reservation time, the system-control unit 516 determines that a notification indicating a cancellation of a reservation has been received (step S110: YES), and processing moves to step S111.

Here, when a user does not make it on time for the reservation time, cancellation contents and contents prompting the user to make a tentative reservation are transmitted from the reservation-management server 100.

Incidentally, when a notification indication cancellation of a reservation is not received within a specified amount of time (for example, 10 minutes) from the reservation time, the system-control unit 516 determines that the user made it on time for the reservation time, and may end processing.

### (Step S111)

The system-control unit 516 causes a tentative-reservation screen (D) 700D to be displayed.

In this case, the system-control unit 516, via the panel-operation-control unit 515, causes the panel unit 503 to display the tentative-reservation screen (D) 700D illustrated in FIG. 6A.

Here, when making a tentative reservation, the user inputs a store code (for example, A001) in the input field 700e, inputs the reservation time (for example, 10:00) in the input field 700g, and touch operates the OK button 700c.

Moreover, when specifying “Nearest”, the user inputs a check (for example, a “X” mark”) in the input field 700f on the tentative-reservation screen (D) 700D illustrated in FIG. 6B, input the reservation time (for example, 10:00) in the input field 700g, and touch operates the OK button 700c.

### (Step S112)

The system-control unit 516 determines whether or not input is complete.

In this case, when there is no notification from the panel-operation-control unit 515 indicating that the OK button 700c on the panel unit 503 has been touch operated, the system-control unit 516 determines that input is not complete (step S112: NO), processing then moves to step S116.

However, when there is a notification from the panel-operation-control unit 515 indicating that the OK button 700c on the panel unit 503 has been touch operated, the system-control unit 516 determines that input is complete (step S112: YES), processing then moves to step S113.

### (Step S113)

The system-control unit 516 transmits tentative-reservation contents.

In this case, the system-control unit 516 transmits contents of the tentative reservation that is inputted on the tentative-reservation screen (D) 700D to the reservation-management server 100.

Incidentally, in step S111, when a check (for example, a “X” mark” is inputted in the input field 700f for selecting “Nearest”, and the contents of the tentative-reservation screen (D) 700D in FIG. 6B are transmitted to the reservation-management server 100, the system-control unit 516, via the GPS-receiving-control unit 514, controls the GPS receiver, and transmits the terminal-position information acquired by the GPS receiver to the reservation-management server 100.

### (Step S114)

The system-control unit 516 determines whether or not a notification indicating that the tentative reservation is complete has been received.

In this case, when the communication-control unit 511 has not received a notification indicating that the tentative reservation is complete, the system-control unit 516 determines that a notification indicating that the tentative reservation is complete has not been received (step S114: NO).

However, when the communication-control unit 511 has received a notification indicating that the tentative reservation is complete, the system-control unit 516 determines that a notification indicating that the tentative reservation is complete has been received (step S114: YES), and processing moves to step S115.

### (Step S115)

The system-control unit 516 causes a tentative-reservation-complete screen (E) 700E to be displayed.

In this case, the system-control unit 516, via the panel-operation-control unit 515, causes the panel unit 503 to display the tentative-reservation-complete screen (E) 700E illustrated in FIG. 7A.

Incidentally, in step S111, when a check (for example, a “X” mark) is inputted in the input field 700f for selecting “Nearest” and the contents of the tentative-reservation screen (D) 700D in FIG. 6B are transmitted to the reservation-management server 100, the system-control unit 516 , via the panel-operation-control unit 515, causes the panel unit 503 to display the tentative-reservation-complete screen (F) 700F illustrated in FIG. 7B. This is because, as described above, even though a tentative reservation is sent to the reservation-management server 100 using the portable terminal 500, the reservation-management server 100 and the reservation-management server 200 are linked, so a case is presumed in which the store nearest the position obtained from the terminal-position information from the portable terminal 500 is a store in the store chain B that is managed by the reservation-management server 200.

### (Step S116)

The system-control unit 516 sets the tentative reservation. When there is a notification indicating that the Confirm button 700h on the tentative-reservation-complete screen (E) 700E or on the tentative-reservation screen (F) 700F has been touch operated, the system-control unit 516 determines that input is complete and notifies the reservation-management server 100 that a tentative reservation is set, then processing moves to step S108.

### (Step S117)

The system-control unit 516 determines whether or not the Cancel button 700d has been operated.

In this case, when there is no notification via the panel-operation-control unit 515 indicating that the Cancel button 700d has been touch operated on the tentative-reservation screen (D) 700D in FIG. 6A, for example, that is displayed on the panel unit 503, the system-control unit 516 determines that the Cancel button 700d has not been operated (step S117: NO), and processing returns to step S112.

However, when there is a notification via the panel-operation-control unit 515 indicating that the Cancel button 700d has been touch operated on the tentative-reservation screen (D) 700D in FIG. 6A, for example, that is displayed on the panel unit 503, the system-control unit 516 determines that the Cancel button 700d has been operated (step S117: YES), and processing moves to step S118.

### (Step S118)

The system-control unit 516 transmits contents indicating a cancellation of the tentative reservation.

In this case, the system-control unit 516, via the communication-control unit 511, transmits contents indicating a cancellation (contents indicating that a tentative reservation will not be made) to the reservation-management server 100.

Next, processing on the reservation-management server 100, 200 side will be explained with reference to FIG. 9. Incidentally, in the following, the case will be explained in which the reservation-management server 100 receives a login request from the portable terminal 500.

### (Step S201)

The system-control unit 116 determines whether or not there is a login request.

In this case, when the communication-control unit 115 has not received a login request from the portable terminal 500, the system-control unit 116 determines that there is no login request (step S201: NO).

However, when the communication-control unit 115 has received a login request from the portable terminal 500, the system-control unit 116 determines that there is a login request (step S201: YES), and processing moves to step S202.

### (Step S202)

The system-control unit 116 determines whether or not authentication is successful.

In this case, when the user ID and password that are included in the login request do not match a user ID and password that are stored in the EEPROM, for example, the system-control unit 116 determines that authentication is not successful (step S202: NO), and processing moves to step S203.

However, when the user ID and password that are included in the login request match a user ID and password that are stored in the EEPROM, for example, the system-control unit 116 determines that authentication is successful (step S202: YES), and processing moves to step S204.

### (Step S203)

The system-control unit 116 notifies that there is an error.

In this case, the system-control unit 116, via the communication-control unit 115, notifies the portable terminal 500 of an error indicating that authentication is not successful.

### (Step S204)

The system-control unit 116 notifies that authentication is successful.

In this case, the system-control unit 116, via the communication-control unit 115, notifies the portable terminal 500 that authentication is successful.

### (Step S205)

The system-control unit 116 determines whether or not reservation contents have been received.

In this case, when the communication-control unit 115 has not received reservation contents that include the store code (for example, A001) and reservation time (for example, 9:00) illustrated in FIG. 4B from the portable terminal 500, the system-control unit 116 determines that reservation contents have not been received (step S205: NO).

However, when the communication-control unit 115 has received reservation contents that include the store code (for example, A001) and reservation time (for example, 9:00) illustrated in FIG. 4B from the portable terminal 500, the system-control unit 116 determines that reservation contents have been received (step S205: YES), and processing moves to step S206.

Incidentally, also in a case in which the communication-control unit 115 has received reservation contents from the portable terminal 500 that include a “Nearest” specification and the reservation time (for example: 9:00) illustrated in FIG. 4C, the system-control unit 116 moves to step S206. In this case, the system-control unit 116 receives terminal-position information from the portable terminal 500.

### (Step S206)

The system-control unit 116 manages the reservation.

In this case, the system-control unit causes the reservation-management unit 113 to manage the reservation.

At this time, the reservation-management unit 113 registers the reservation time (for example, 9:00) and the reservation number (for example, 001A-01) that corresponds to the store code (for example, A001) received from the portable terminal 500 in the reservation-information column 125 of the reservation-management table 120 illustrated in FIG. 3A.

Moreover, when terminal-position information is received from the portable terminal, the system-control unit 116 causes the position-management unit 114 to manage the terminal-position information of the portable terminal 500.

### (Step S207)

The system-control unit 116 notifies that the reservation is complete.

In this case, the system-control unit 116, via the communication-control unit 115, notifies the portable terminal 500 that the reservation is complete.

Incidentally, in step S205, when the communication-control unit 115 receives reservation contents from the portable terminal 500 that includes a “Nearest” specification and the reservation time (for example, 9:00) illustrated in FIG. 4C, the system-control unit 116 causes the position-management unit 114 to manage the terminal position information of the portable terminal 500. Moreover, the system-control unit 116 references the store-position information in the reservation-management table 120, and searches for the nearest store from the terminal-position information that is managed by the position-management unit 114.

Furthermore, the system-control unit 116 requests the reservation-management server 200 on the store chain B side to search for a store. In this case, the system-control unit 116 transmits the terminal-position information that is managed by the position-management unit 114 to the reservation-management server 200 on the store chain B side. The reservation-management server 200 on the store chain B side manages the terminal-position information of the portable terminal 500 that the position-management unit 214 received from the reservation-management server 100. In addition, the system-control unit 216 references the store-position information in the reservation-management table illustrated in FIG. 3B, and searches for the nearest store to the portable terminal 500, then notifies the reservation-management server 100 on the store chain A side.

The system-control unit of the reservation-management server 100 on the store chain A side compares the positions of the stores searched from the store-position information in the reservation-management table 120 with the position of the stores received from the reservation-management server 200 on the store chain B side, and notifies the portable terminal 500 of the nearest store.

In this case, when a store in the store chain A is nearer to the position of the portable terminal 500 than a store in the store chain B, the reservation-complete screen (B) 700B illustrated in FIG. 5A is displayed on the panel unit 503 of the portable terminal 500. On the other hand, when a store in the store chain B is nearer to the position of the portable terminal 500 than a store in the store chain A, the reservation-complete screen (C) 700C illustrated in FIG. 5B is displayed on the panel unit 503 of the portable terminal 500.

Moreover, the system-control unit 116 of the reservation-management server 100, via the communication-control unit 115, transmits reservation information (for example, 9:00) to the MFP 300 having a MFP management code 001A that corresponds to the store code (for example, A001), and instructs the MFP 300 of the standby time for restricting the use of the functions by other users before the start of the reservation time. In this case, the reservation-management unit 315 of the MFP 300 manages the reservation information (for example, 9:00) and the standby time. The system-control unit 321 of the MFP 300 restricts use of the MFP 300 by other users during the standby time. For example, the system-control unit 321 does not allow login by other users during the standby time.

As a result, the user that reserved the MFP 300 is able to immediately use the MFP 300 without having to wait for other users to finish using the MFP 300.

### (Step S208)

The system-control unit 116 determines whether or not the time is the reservation time.

In this case, when the system-control unit 116 references the reservation-information column 125 of the reservation-management table 120 and the time indicated by a timer has not yet reached the reservation time (for example, 9:00) that is registered in the reservation-information column 125, the system-control unit 116 determines that the time is not the reservation time (step S208: NO).

However, when the system-control unit 116 references the reservation-information column 125 of the reservation-management table 120 and the time indicated by a timer has reached the reservation time (for example, 9:00) that is registered in the reservation-information column 125, the system-control unit 116 determines that the time is the reservation time (step S208: YES), and processing moves to step S209.

### (Step S209)

The system-control unit 116 determines whether or not a reservation number has been received.

In this case, when there is no notification from the system-control unit 321 of the MFP 300 via the communication-control unit 115 indicating that a reservation number (for example, 001A-01) has been received, the system-control unit 116 determines that a reservation number (for example, 001A-01) has not been received (step S209: NO), and processing moves to step S210.

However, when there is a notification from the system-control unit 321 of the MFP 300 via the communication-control unit 115 indicating that a reservation number (for example, 001A-01) has been received, the system-control unit 116 determines that a reservation number (for example, 001A-01) has been received (step S209: YES), and processing moves to step S215.

### (Step S210)

The system-control unit 116 determines whether or not a fixed amount of time has elapsed.

In this case, when the time of a timer indicates that 10 minutes, for example, has not elapsed from the reservation time (for example: 9:00), the system-control unit 116 determines that a fixed amount of time has not elapsed (step S210: NO).

However, when the time of a timer indicates that 10 minutes, for example, has elapsed from the reservation time (for example: 9:00), the system-control unit 116 determines that a fixed amount of time has elapsed (step S210: YES), and processing moves to step S211. Incidentally, when a fixed amount of time has elapsed after a fixed amount of time has elapsed, and a notification is received from the MFP 300 indicating a cancellation of the reservation, processing may move to step S211.

### (Step S211)

The system-control unit 116 notifies of a cancellation of the reservation and contents prompting the making of a tentative reservation.

In this case, the system-control unit 116, via the communication-control unit 115, notifies the portable terminal 500 of a cancellation of the reservation and contents prompting that a tentative reservation be made. Moreover, the system-control unit 116 causes the reservation-management unit 113 to delete the reservation from the reservation management tables 120, 125.

At this time, the tentative-reservation screen (D) 700D illustrated in FIG. 6A is displayed on the panel unit 503 of the portable terminal 500.

Here, when making a tentative reservation, the user inputs a store code (for example, A001) in the input field 700e, inputs the reservation time (for example, 10:00) in the input field 700g, and touch operates the OK button 700c on the tentative-reservation screen (D) 700D illustrated in FIG. 6A.

Moreover, when making a tentative reservation at the nearest store, the user inputs a check (for example, a “X” mark) in the input field 700f, inputs the reservation time (for example, 10:00) in the input field 700g, and touch operates the OK button 700c as in the case of the tentative-reservation screen (D) 700D illustrated in FIG. 6B.

When making a tentative reservation at the nearest store, the portable terminal 500, as described above, transmits terminal-position information to the reservation-management server 100.

Incidentally, when not making a tentative reservation, the user touch operates the Cancel button 700d.

### (Step S212)

The system-control unit 116 determines whether or not contents of a tentative reservation have been received.

In this case, when the communication-control unit 115 has not received contents of a tentative reservation from the portable terminal 500, the system-control unit 116 determines that contents of a tentative reservation have not been received (step S212: NO).

However, when the communication-control unit 115 has received contents of a tentative reservation from the portable terminal 500, the system-control unit 116 determines that contents of a tentative reservation have been received (step S212: YES), and processing moves to step S213.

Incidentally, when the communication-control unit 115 receives contents indicating a cancellation of a tentative reservation, the system-control unit 116 causes the reservation-management unit 113 to delete the tentative reservation from the reservation-management tables 120, 220, and ends processing.

### (Step S213)

The system-control unit 116 causes the tentative reservation to be managed.

In this case, the system-control unit 116 causes the reservation-management unit 113 to manage the tentative reservation.

At this time, the reservation-management unit 113 registers the tentative-reservation time (for example, 10:00) and the tentative-reservation number (for example, 101A-01) in the tentative-reservation-information field 126 that corresponds to the store code (for example, A001) that is received from the portable terminal 500 in the reservation-management table 120 illustrated in FIG. 3A.

Moreover, as described above, when terminal-position information is received from the portable terminal 500, the system-control unit 116 causes the position-management unit 114 to manage the terminal-position information of the portable terminal 500.

In other words, in step S212, when the communication-control unit 115 receives tentative-reservation contents from the portable terminal 500 that include a “Nearest” specification and the reservation time (for example, 10:00) illustrated in FIG. 6B, the system-control unit 116 acquires the terminal-position information from the portable terminal 500.

### (Step S214)

The system-control unit 116 notifies that the tentative reservation is complete.

In this case, the system-control unit 116, via the communication-control unit 115, notifies the portable terminal 500 that the tentative reservation is complete.

Moreover, as described above, when tentative-reservation contents that include a “Nearest” specification and the reservation time (for example, 10:00) illustrated in FIG. 6B, the system-control unit 116 references the store-position-information field 123 of the reservation-management table 120, and searches for the nearest store to the portable terminal 500. In addition, the system-control unit 116 requests a search of stores in the reservation-management table 220 on the store chain B side. In this case, the system-control unit 116 transmits the terminal-position information from the portable terminal 500 to the reservation-management server 200 on the store-chain B side.

In the reservation-management server 200 on the store chain B side, the system-control unit 216 references the store-position-information column 223 of the reservation-management table 220 illustrated in FIG. 3B and searches for the store that is nearest to the portable terminal 500, then notifies the reservation-management server 100 on the store chain A side.

The system-control unit 116 of the reservation-management server 100 on the store chain A side compares the position of the store searched from the store-position-information column 123 of the reservation-management table 120 with the position of the store received from the reservation-management server 200 on the store chain B side, and notifies the portable terminal 500 of the store nearest to the portable terminal 500.

In this case, when a store in store chain A is nearer to the position of the portable terminal 500 than a store in the store chain B, the tentative-reservation-complete screen (E) 700E illustrated in FIG. 7A is displayed on the panel unit 503 of the portable terminal 500. On the other hand, when a store in store chain B is nearer to the position of the portable terminal 500 than a store in the store chain A, the tentative-reservation-complete screen (F) 700F illustrated in FIG. 7B is displayed on the panel unit 503 of the portable terminal 500.

Incidentally, for a tentative reservation, a standby time that restricts the use of the function by other users before the start of the reservation time is not set.

### (Step S215)

The system-control unit 116 changes the tentative reservation to a real reservation.

After receiving a notification from the portable terminal 500 indicating that a tentative reservation is set, the system-control unit 116 changes the tentative reservation to a real reservation, transmits the contents of the real reservation that is changed from the tentative reservation to the reservation-management server 200 that manages the MFP 400 at the reserved store, and causes the reservation-management unit 113 to delete the real reservation that is changed from the tentative reservation from the reservation-management tables 120, 220.

After receiving the contents of the real reservation from the reservation-management server 100, the system-control unit 216 of the reservation-management server 200 starts processing from step S206. Incidentally, in the process from step S206 to step S216 that is executed by the reservation-management server 200, it is understood in the explanation above that the reservation-management server 100 is replaced by the reservation-management server 200.

### (Step S216)

The system-control unit 116 determines whether or not the use of the MFP 300 is complete.

In this case, when the communication-control unit 115 has not received a notification from the MFP 300 indicating that use of the MFP 300 by the user that reserved the MFP 300 is complete, the system-control unit 116 determines that use of the MFP 300 is not complete (step S216: NO).

However, when the communication-control unit 115 has received a notification from the MFP 300 indicating that use of the MFP 300 by the user that reserved the MFP 300 is complete, the system-control unit 116 determines that use of the MFP 300 is complete (step S216: YES), and processing ends.

At this time, the system-control unit 116 notifies the reservation-management unit 113 that use of the MFP 300 by the user that reserved the MFP 300 is complete. As a result, the reservation-management unit 113 deletes the reservation time (for example, 9:00) and the reservation number (for example, 001A-01) that are registered in the reservation-information column 125 of the reservation-management table 120.

Incidentally, as in the case in which use of the MFP 300 by a user that made a tentative reservation is complete, the reservation-management unit 113 deletes the tentative reservation time (for example, 10:00) and the tentative-reservation number (for example 101A-01), for example, that are registered in the tentative-reservation-information column 126 of the reservation-management table 120.

In this way, in this embodiment, the reservation-management unit 113 or 213 (first reservation-management unit) of the reservation-management server 100 or 200 manages a store code that identifies a stores where a MFP 300 or 400 (shared apparatus) is installed, store-position information of the store, a management code for managing the MFP 300 or 400 (shared apparatus), and reservation information that includes reservation times and reservation numbers. Moreover, the system-control unit 116 or 216 (first system-control unit) receives a reservation request including the reservation time and terminal-position information from the portable terminal 500, searches for a store that is near the terminal-position information based on the store-position information, causes the reservation-management unit 113 or 213 (first reservation-management unit) to manage the reservation time by correlating the reservation time with the store code of the searched store, notifies the portable terminal 500 of the store-position information of the searched store and the reservation number, and transmits the reservation time and reservation number to the MFP 300 or 400 (shared apparatus) based on the management code. Together with this, the system-control unit 116 or 216 (first system-control unit) gives instruction for a standby time that restricts the use of the functions of the MFP 300 or 400 (shared apparatus) by other users before the start of the reservation time.

Moreover, in this embodiment, the reservation-management unit 113 or 213 (first reservation-management unit) of the reservation-management server 100 or 200 manages a store code that identifies a store where a MFP 300 or 400 (shared apparatus) are installed, and reservation information that includes a reservation time and reservation number. Moreover, the system-control unit 116 or 216 (first system-control unit) receives a reservation request including the store code and reservation time from the portable terminal 500, causes the reservation-management unit 113 or 213 (first reservation-management unit) to manage the reservation time by correlating the reservation time with the store codes, and transmits the reservation time and reservation number to the MFP 300 or 400 (shared apparatus) that corresponds to a management code. Together with this, the system-control unit 116 or 216 (first system-control unit) gives an instruction for a standby time for restricting use of the functions of the MFP 300 or 400 (shared apparatus) by other users before the start of the reservation time.

In this case, a MFP 300 or 400 (shared apparatus), by the reservation-management unit 315 (second reservation-management unit), manages the reservation time, the reservation number and the standby time. Moreover, a system-control unit 321 (second system-control unit) restricts the use of functions by setting a standby time that restricts use by other users before the start of the reservation time that is managed by the reservation-management unit 315 (second reservation unit). Together with this, when there is no input of a reservation number even after a set amount of time has elapsed from the reservation time, the system-control unit 321 (second system-control unit) cancels the reservation.

In this way, the reservation-management server 100 or 200, in addition to transmitting a reservation time and reservation number to the MFP 300 or 400 (image forming apparatus), by giving an instruction for a standby time that restricts the use of the functions of the MFP 300 or 400 by other users before the start of the reservation time, the MFP 300 or 400 (shared apparatus) sets a standby time that restricts the use by other users before the start of the reservation times. Therefore, a user that reserved an image forming apparatus is able to use the image forming apparatus immediately from the start of the reservation time, so it is possible to suppress a decrease in convenience to the user.

On the other hand, on the store side, when a reservation number is not inputted even after a fixed amount of time has elapsed from the reservation time, the MFP 300 or 400 (shared apparatus) releases the restriction on the use of the functions, so when a user does not make it on time for the reservation time, it becomes possible for other users to use the MFP 300 or 400 (shared apparatus) after a fixed amount of time. Therefore, it is possible to suppress a decrease in the availability of the MFP 300 or 400 (shared apparatus).

Moreover, the standby time may be a specified amount of time before and after the reservation time. However, the standby time is presumed to be a fixed amount of elapsed time or an amount of time up to just before a fixed amount of time explained in step S210 in FIG. 9 after the reservation time.

Furthermore, in steps S109 to S110 illustrated in FIG. 8, the system-control unit 516 of the portable terminal 500 may determine whether or not a notification is received indicating a tentative-reservation request. In this case, when a notification is received before the reservation from the panel-control unit 515 indicating a tentative-reservation request by a user touch operating the panel unit 503, the system-control unit causes the panel unit 503 to display the tentative-reservation screen (D) 700D, and executes processing similar to that of step S112 to S116. The system-control unit 116 of the reservation-management server 100 executes processing according to steps S213 to S215 illustrated in FIG. 9. Here, in step S215, the system-control unit 116 transmits an instruction to cancel the original reservation, and causes the reservation-management unit 113 to delete the original reservation from the reservation-management table 120. The system-control unit 321 of the MFP 300 cancels the original reservation and releases the restriction of the use of the MFP 300 by other users. Incidentally, in step S215, the system-control unit 516 may transmit a notification to the reservation-management server 100 indicating that a reservation is cancelled. In this case, when a notification is received from the portable terminal 500 indicating a cancellation, the system-control unit 116 of the reservation-management server 100 executes processing for cancelling the original reservation as described above.

Moreover, the system-control unit 321 of the MFP 300 does not need to cancel a reservation even though a fixed amount of time elapses from the reservation time. In this case, in step S211 illustrated in FIG. 9, instead of executing processing for cancelling a reservation, the system-control unit 116 of the reservation-management server 100 may correct the reservation, or more specifically, move the reservation to after a fixed amount of time (for example, 15 minutes). The reservation-management unit 113 corrects the reservation time of the reservation corresponding to the reservation-management table 120. The system-control unit 116 notifies the portable terminal of contents indicating a correction of the reservation time and contents prompting the making of a tentative reservation. Furthermore, the system-control unit 116 transmits an instruction for correcting the reservation time to the MFP 300. After receiving contents indicating a correction of the reservation time and contents prompting the making of a tentative reservation, the system-control unit 516 of the portable terminal 500 executes processing from step S111 on as illustrated in FIG. 8. The system-control unit 321 of the MFP 300 corrects the reservation time according to the instruction from the reservation-management server 100. After a fixed amount of time (for example, 10 minutes) has elapsed since a notification prompting the making of a tentative reservation has been transmitted, or after a notification indicating that a tentative reservation has been set in step S116, the system-control unit 116 of the reservation-management server 100 may execute processing for cancelling the original reservation.

In addition, after a fixed amount of time (for example, 10 minutes) has elapsed since a notification prompting the making of a tentative reservation is transmitted, the system-control unit 116 of the reservation-management server 100 may cause the reservation-management unit 113 to delete the tentative reservation from the reservation-management tables 120, 220.

In the embodiment described above, the case of reserving an image forming apparatus is explained, however, the technology according to the present disclosure can also be applied to shared apparatuses other than an image forming apparatus, for example, a kiosk terminal and the like.

In a typical example of a printing-service-providing method described above, a server terminal compares service-reservation-condition information that is transmitted from a user-reservation terminal with service-receivable-condition information that is transmitted from a dealer-reservation-receiving terminal. Then, service-receiving information based on user-high-suitability-service-receivable-condition information for which suitability equal to or greater than a user-standard-condition suitability is transmitted to a user-reservation terminal. Therefore, an image forming apparatus can be used more efficiently.

Incidentally, this printing-service-providing method presumes that a specified printing service is received by a user going to a store where an image forming apparatus is installed at a reserved time. Therefore, even though a user may make it on time for the reservation time, when a user that reserved the image forming apparatus before is still using the image forming apparatus, the user must wait for the image forming apparatus to become vacant, so there is a decrease in the convenience to the user.

On the other hand, on the store side, taking user convenience into consideration, when a user that has reserved an image forming apparatus does not make it on time to the reservation time, the estimated time of arrival of the user is checked, and except for reservation times of the image forming apparatus by other users, it is considered possible to shift the reservation time to the estimated time of arrival. However, when the reservation time is shifted for a user that does not make it on time for the reservation time, other users are not able to make reservations, and the availability of the image forming apparatus decreases.

Due to this situation, construction of a reservation-management system is desired that is capable of suppressing a decrease in user convenience and availability of an image forming apparatus.

In the reservation-management system, reservation-management server and reservation management program according to the present disclosure, on the reservation-management server side, a first reservation-management unit manages a store code that identifies a store, store-position information that indicates the positions of the store, a management code that manages a shared apparatus, and reservation information that includes a reservation time and reservation number. Then, a first system-control unit receives a reservation request from a portable terminal that includes a reservation time, searches for the store based on the reservation request, causes the first reservation-management unit to manage the reservation time by correlating the reservation time with the store code of the searched store, notifies the portable terminal of the store-position information of the searched store and the reservation number, and transmits the reservation time and reservation number to the shared apparatus based on the management code. Together with this, the first system-control unit gives an instruction for a standby time for restricting the use of functions of the shared apparatus by other users before the start of the reservation time.

On the other hand, on the shared apparatus side, a second reservation-management unit manages the reservation time, the reservation number, and the standby time. Moreover, a second system-control unit restricts use of functions by setting a standby time that restricts the use by other users before the start of the reservation time managed by the second reservation-management unit. Together with this, when there is no input of the reservation number even though a fixed amount of time elapses from the reservation time, the second system-control unit cancels the reservation.

In this way, in addition to the reservation-management server transmitting the reservation time and reservation number to the shard apparatus, by giving an instruction for a standby time that restricts use of the functions of the shared apparatus by other users before the start of the reservation time, the shared apparatus sets a standby time for restricting use by other users before the start of the reservation time. Therefore, the user that made a reservation is able to use the shared apparatus immediately from the reservation time.

On the other hand, on the store side, when there is no input of the reservation number even though a fixed amount of time has elapsed from the reservation time, the shared apparatus releases the restriction on the use of the functions. Therefore, when a user that has a reservation does not make it on time for the reservation time, it is possible for other users to use the shared apparatus after a fixed amount of time.

With the reservation-management system and reservation-management server according to the present disclosure, a user that has a reservation is able to use a shared apparatus immediately from the reservation time, and on the store side, when a user having a reservation does not make it on time for the reservation time, the shared apparatus can be used by other users after a fixed amount of time. Therefore a decrease in the convenience to the user and the availability of the shared apparatus can be suppressed.

What is claimed is:

1. A reservation-management system, comprising:
a reservation-management server;
a shared apparatus that is installed in a store;
a portable terminal that, via the reservation-management server, requests a reservation for a shared apparatus; wherein
the reservation-management server has:
a first reservation-management unit for managing a store code for identifying the store, store-position information that indicates the position of the store, a management code for managing the shared apparatus, and reservation information that includes a reservation time and reservation number; and
a first system-control unit that receives a reservation request from the portable terminal that includes the reservation time, searches for the store based on the reservation request, causes the first reservation-management unit to manage the reservation time by correlating the reservation time with the store code of the searched store, notifies the portable terminal of the store-position information of the searched store and the reservation number, transmits the reservation time and the reservation number to the shared apparatus based on the management code, and together with this, gives an instruction for a standby time for restricting the use of the functions of the shared apparatus by other users before the start of the reservation time;
the shared apparatus has:
a second reservation-management unit for managing the reservation time, the reservation number and the standby time; and
a second system-control unit that sets a standby time for restricting use by other users before the start of the reservation time managed by the second reservation-management unit, and restricts use of the functions; and
the second system-control unit releases the restrictions on use of the functions when there is no input of the reservation number even after a fixed amount of time has elapsed from the reservation time.

2. The reservation-management system according to claim 1, wherein
the portable terminal
has a third system-control unit that transmits contents of a tentative reservation for the image forming apparatus via the reservation, and sets the tentative reservation;
the first system-control unit
receives the contents of the tentative reservation and causes the first reservation-management unit to manage the tentative reservation, and
when the tentative reservation is set, changes the tentative reservation to a real reservation, and causes the first reservation-management unit to manage the real reservation.

3. The reservation-management system according to claim 1, wherein
the second system-control unit, when there is no input of the reservation number even though a fixed amount of time has elapsed from the reservation time, cancels the reservation, and notifies the reservation-management server that the reservation is cancelled; and
the first system-control unit, in addition to notifying the portable terminal that the reservation is cancelled, notifies the portable terminal of contents prompting the making of a tentative reservation.

4. The reservation-management system according to claim 2, wherein after receiving a notification of the contents prompting the making of a tentative reservation, transmits, via the reservation-management server, contents of the tentative reservation of the shared apparatus.

5. The reservation-management system according to claim 2, wherein when the tentative reservation is set, the second system-control unit cancels the reservation.

6. The reservation-management system according to claim 2, wherein
the first system-control unit, when the time becomes the reservation time, transmits an instruction to the shared apparatus to move the reservation time back a fixed amount of time, and notifies the portable terminal of contents prompting the making of a tentative reservation;
the second system-control unit corrects the reservation time according to the instruction; and
the third system-control unit, after receiving the notification of contents prompting the making of a tentative reservation, transmits, via the reservation-management server, contents of the tentative reservation for the shared apparatus.

7. The reservation-management system according to claim 2, wherein the second system-control unit does not restrict the use of the shared apparatus by other users according to the tentative-reservation time of the tentative reservation.

8. A reservation-management server, comprising:
a first reservation-management unit that manages a store code for identifying a store where an image forming apparatus is installed, store-position information of the store, a management code for managing the image forming apparatus, and reservation information that includes a reservation time and reservation number; and
a first system-control unit that receives a reservation request from the portable terminal that includes the reservation time, and terminal-position information that indicates the position of the portable terminal, searches for the store based on the store-position information and the terminal-position information, causes the first reservation management unit to manage the reservation time by correlating the reservation time with the store code of the searched store, notifies the portable terminal of the store-position information and the reservation number of the searched store, transmits the reservation time and reservation number to the image forming apparatus based on the management code, and together with this, gives an instruction for a standby time for restricting the use of the functions of the image forming apparatus by other users before the start of the reservation time.

9. A reservation-management server, comprising:
a first reservation-management unit that manages a store code for identifying a store where an image forming apparatus is installed, a management code for managing the image forming apparatus, and reservation information that includes a reservation time and reservation number; and
a first system-control unit that receives a reservation request from the portable terminal that includes the store code and the reservation time, causes the first reservation management unit to manage the reservation time by correlating the reservation time with the store code, transmits the reservation time and reservation number to the image forming apparatus according to the management code, and together with this, gives an instruction for a standby time for restricting the use of the functions of the image forming apparatus by other users before the start of the reservation time.
